(19) United States
(12) Patent Application Publication
(10) Pub. No.: US 2024/0286043 A1
(43) Pub. Date: Aug. 29, 2024

(54) VERIFYING TRUSTED EXECUTION ENVIRONMENTS FOR ONLINE APPLICATIONS USING IN-APPLICATION CONTENT

(71) Applicant: NVIDIA Corporation, Santa Clara, CA (US)

(72) Inventors: Lucien Dunning, Ramsey, NJ (US); Seth Schneider, San Jose, CA (US); Dwayne Swoboda, San Jose, CA (US); Marko Mitic, San Jose, CA (US); Daniel Rohrer, Cary, NC (US)

(21) Appl. No.: 18/174,163

(22) Filed: Feb. 24, 2023

(51) Int. Cl. A63F 13/73; A63F 13/75; H04L 9/40

(52) U.S. Cl. CPC A63F 13/73; A63F 13/75; H04L 63/20

(57) ABSTRACT

In examples, properties of an execution environment may be verified for a game session to comply with security policies based at least on analyzing attestation reports generated using one or more host devices. Content items may be associated with the game session to indicate the verification for presentation with a live stream video of the game session, in a pre-recorded video of the game session, and/or in another user interface associated with the game session. A record of the verification may be stored in a database, and the database may be queried to display the content item and/or to determine whether the verification occurred. The attestation reports may include an attestation report(s) generated using an input device(s) used to capture user inputs for the game session, such as an input device used to control the game session and/or provide a video capture of the player during the game session.

### BACKGROUND

Software applications, especially gaming applications that are played online with others, are increasingly being used for entertainment, socialization, and competition (e.g., via eSports). With this increase, there has also been a rise in mechanisms and techniques that enable cheating in video games. Cheating in a video game allows a player to gain an unfair advantage relative to other, non-cheating participants or competitors. Some cheats augment the information available to a player, for example, allowing the player to see opponents through walls, or otherwise have access to information regarding an opponent's health, position or location, items, or other in-game information that the player would not ordinarily have, or was not intended to have by the game developers. Other cheats augment player inputs, such as to aim and/or trigger for a player or nudge a player cursor. Still other cheats disable in-game effects, such as smoke or fog which would otherwise obscure the player's vision. Additionally, some cheats transform player inputs, such as to increase cursor stability or to compensate for in-game effects.

With the variety and sophistication of cheats in gaming, it is difficult for players and viewers of games to reliably determine whether a player is cheating or for a player to prove they are not cheating. Conventionally, a game service and/or game may include anti-cheat features to be installed on a player's system in order to connect to a gaming service. However, new techniques for cheating as well as for circumventing detection are constantly being developed. To assist viewers and other players with determining whether a player is cheating, the player may set up a camera to live stream themselves as they play a game. However, video alone cannot capture the underlying hardware and software state of the player's gaming system. Further, it is impractical for other players or viewers to keep track of each player in a game via video.

### SUMMARY

Embodiments of the present disclosure relate to using in-application content to signify verification of trusted execution environments for gaming. In particular, the disclosure relates to approaches for providing indications to users that participants in application sessions, such as gaming sessions, are using execution environments that are resilient to unauthorized application usage, such as cheating.

In contrast to conventional approaches, such as those described above, disclosed approaches may verify one or more properties of one or more execution environments for participating in one or more game sessions comply with one or more security policies. To verify the properties, data corresponding to one or more attestation reports generated using one or more host devices may be analyzed. One or more in-application content items or units may be associated with the game session(s) to indicate the execution environment(s) complies with the security policies. Based at least on the item(s) or unit(s) of in-application content being associated with the game session(s), a graphical representation of the in-application content items or units may be presented during a session of the application (e.g., gaming session). For example, a unit or item of in-application content may include an object or item that is graphically depicted with a live stream video of the game session, in a pre-recorded video of the game session, and/or in another user interface associated with the game session. In at least one embodiment, one or more records of the one or more properties being verified may be stored in a data store, such as a database. The database may be queried to display the content item(s) and/or to determine whether the one or more properties have been verified for a user and/or game session.

Further aspects of the disclosure provide approaches for verifying user inputs to application sessions. For example, one or more attestation reports may be generated using one or more input devices used to capture user inputs for an application(s), and one or more properties thereof may be verified. The attestation report(s) may be provided over a secure communication channel to a secure enclave (which may include the execution environment for the application) for the verification. The verification may be performed using the secure enclave and/or an external attestation service. In at least one embodiment, the input device(s) includes a video camera(s) and the application(s) include a video streaming application. A chain of attestation reports may be generated to capture entities that processes and/or transmits corresponding video data in a video stream. The chain of attestation may be used to determine whether the video data is trustworthy, such as for deepfake protection and/or persona verification.

### BRIEF DESCRIPTION OF THE DRAWINGS

The present systems and methods for using content items to signify verification of trusted execution environments for gaming are described in detail below with reference to the attached drawing figures, wherein:

FIG. 1 depicts an example of a gaming verification system, in accordance with some embodiments of the present disclosure;

FIG. 2 illustrates an example of a webpage displaying player information in association with one or more content items signifying verification of a player's gaming system, in accordance with some embodiments of the present disclosure;

FIG. 3 is a flow diagram showing a method which may be used to associate a content item with a game session, in accordance with some embodiments of the present disclosure;

FIG. 4 is a flow diagram showing a method which may be used to present a content item with a game session, in accordance with some embodiments of the present disclosure;

FIG. 5 depicts an example of a trust verification system which may be used to implement the gaming verification system of FIG. 1, in accordance with some embodiments of the present disclosure;

FIG. 6 illustrates an example of an architecture that may enable an untrusted host OS and a virtual machine to use corresponding GPU state data within a GPU, in accordance with some embodiments of the present disclosure;

FIG. 7 illustrates an example of a hypervisor controlling a memory management unit and address translation to isolate GPU state data and a VM from untrusted entities, in accordance with some embodiments of the present disclosure;

FIG. 8 illustrates an example of using a GPU root of trust for attestation, in accordance with some embodiments of the present disclosure;

FIG. 9 depicts an example of a user input verification system which may be used for verifying user input, in accordance with some embodiments of the present disclosure;

FIG. 10 depicts an example of a video input verification system, in accordance with some embodiments of the present disclosure;

FIG. 11 is a block diagram of an example content streaming system suitable for use in implementing some embodiments of the present disclosure;

FIG. 12 is a block diagram of an example computing device suitable for use in implementing some embodiments of the present disclosure; and

FIG. 13 is a block diagram of an example data center suitable for use in implementing some embodiments of the present disclosure.

### DETAILED DESCRIPTION

The present disclosure relates to using content items to signify verification of trusted execution environments for gaming. In particular, the disclosure relates to approaches for providing indications to users that participants in application sessions, such as gaming sessions, are using execution environments that are resilient to unauthorized application usage, such as cheating.

The systems and methods described herein may be used for a variety of purposes, by way of example and without limitation, these purposes may include systems or applications for online multiplayer gaming, machine control, machine locomotion, machine driving, synthetic data generation, model training, perception, augmented reality, virtual reality, mixed reality, robotics, security and surveillance, autonomous or semi-autonomous machine applications, deep learning, environment simulation, data center processing, conversational AI, light transport simulation (e.g., ray tracing, path tracing, etc.), collaborative content creation for 3D assets, digital twin systems, cloud computing and/or any other suitable applications.

Disclosed embodiments may be comprised in a variety of different systems such as systems for participating on online gaming, automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for generating or maintaining digital twin representations of physical objects, systems implemented at least partially using cloud computing resources, and/or other types of systems.

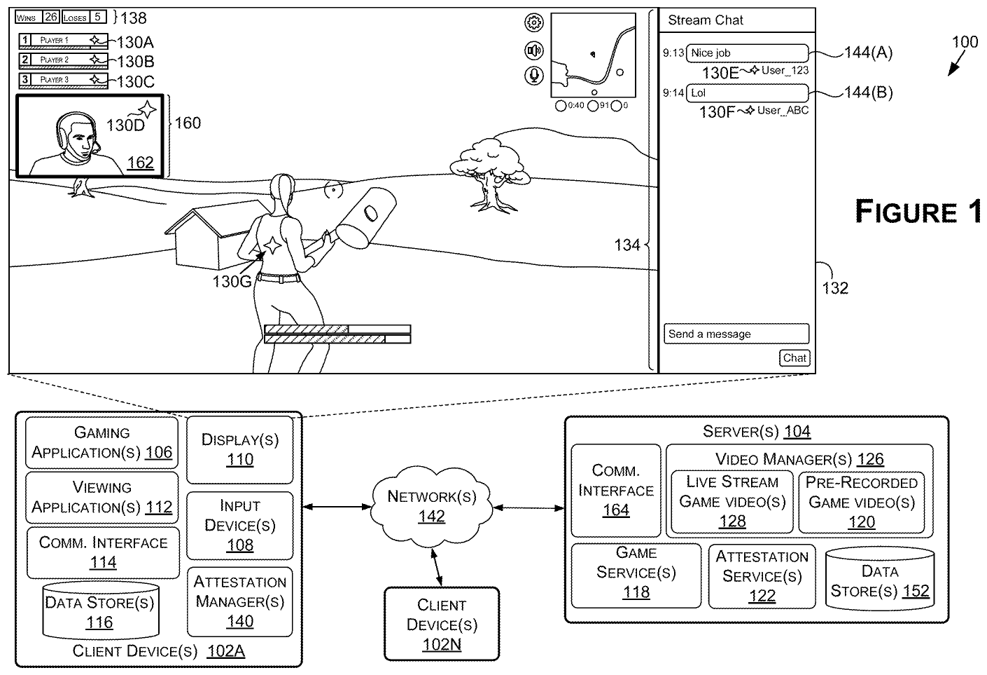

FIG. 1 depicts an example of a gaming verification system 100 (also referred to herein as “system 100”), in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The system 100 may be implemented using, among additional or alternative components, one or more client devices, such as client devices 102A through 102N (also referred to as “client devices 102”), one or more servers, such as a server(s) 104, and one or more networks, such as a network(s) 142.

Each of the devices and/or components of the system 100 may communicate over the network(s) 142. The network(s) 142 may include a wide area network (WAN) (e.g., the Internet, a public switched telephone network (PSTN), etc.), a local area network (LAN) (e.g., Wi-Fi, ZigBee, Z-Wave, Bluetooth, Bluetooth Low Energy (BLE), Ethernet, etc.), a global navigation satellite system (GNSS) network (e.g., the Global Positioning System (GPS)), and/or another network type. In any example, each of the devices or components of the system 100 may communicate with one or more of the other devices and/or components via one or more of the networks 142.

A client device(s) 102 may include one or more of a personal computer (PC), a smart phone, a laptop computer, a tablet computer, a desktop computer, a wearable device, a smart watch, a mobile device, a touch-screen device, a game console, a virtual reality system (e.g., a headset, a computer, a game console, remote(s), controller(s), and/or other components), a streaming device, (e.g., an NVIDIA SHIELD), a smart-home device that may include an intelligent personal assistant, a server, a data center, a Personal Digital Assistant (PDA), an MP3 player, a virtual reality headset, a Global Positioning System (GPS) or device, a video player, a video camera, a surveillance device or system, a vehicle, a boat, a flying vessel, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device. In one or more embodiments, a client device 102 may include a device capable of supporting at least display of an application stream of an application session, such as an application session 132 and/or inputs to the application session 132 from one or more input devices, such as an input device(s) 508.

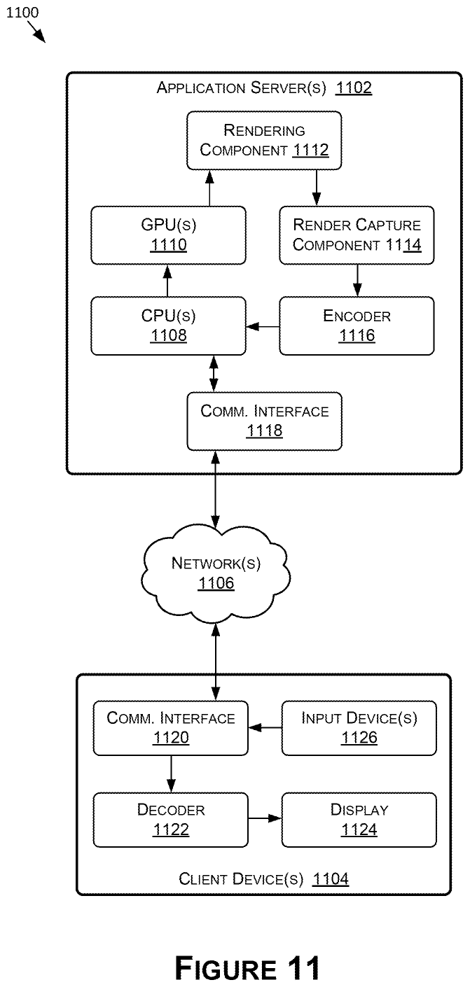

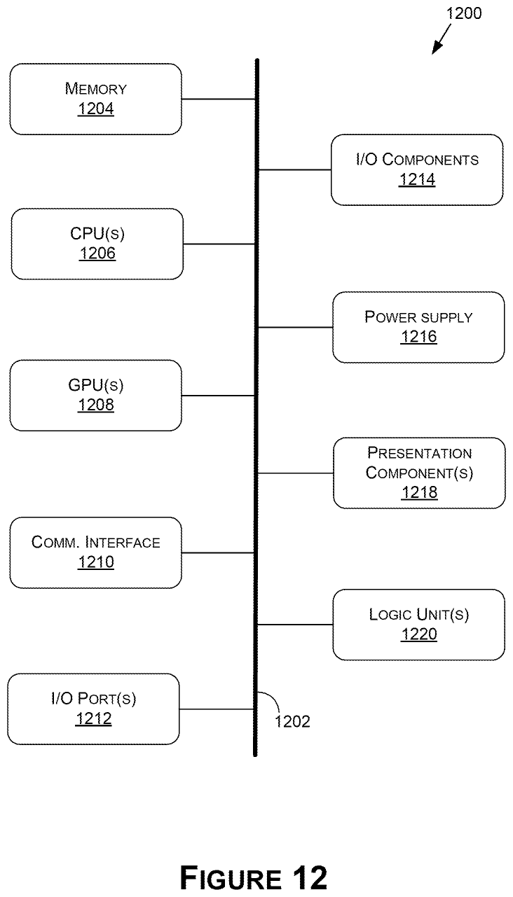

A client device(s) 102 may include a game application(s) 106, the input device(s) 508, a display(s) 110, a viewing application(s) 112, a communication interface 114, a data store(s) 116, and an attestation manager(s) 140. Although only a few components and/or features of a client device(s) 102 are illustrated in FIG. 1, this is not intended to be limiting. For example, the client device(s) 102 may include additional or alternative components, such as the client device(s) 1104 of FIG. 11 and/or the computing device 1200 of FIG. 12.

In one or more embodiments, a client device(s) 102 may execute an instance of an application, such as a game (e.g., the game session 132) using a game application 106. In one or more embodiments, a client device(s) 102 may receive display data (e.g., encoded display data, as described with respect to FIG. 11) and use the display data to display the output produced by the instance on the display 110. In examples where the display data is received by a client device(s) 102 (e.g., where the client device(s) 102 does not generate the rendering), the system 100 may be part of a game streaming system, such as the content streaming system 1100 of FIG. 11, described in more detail below.

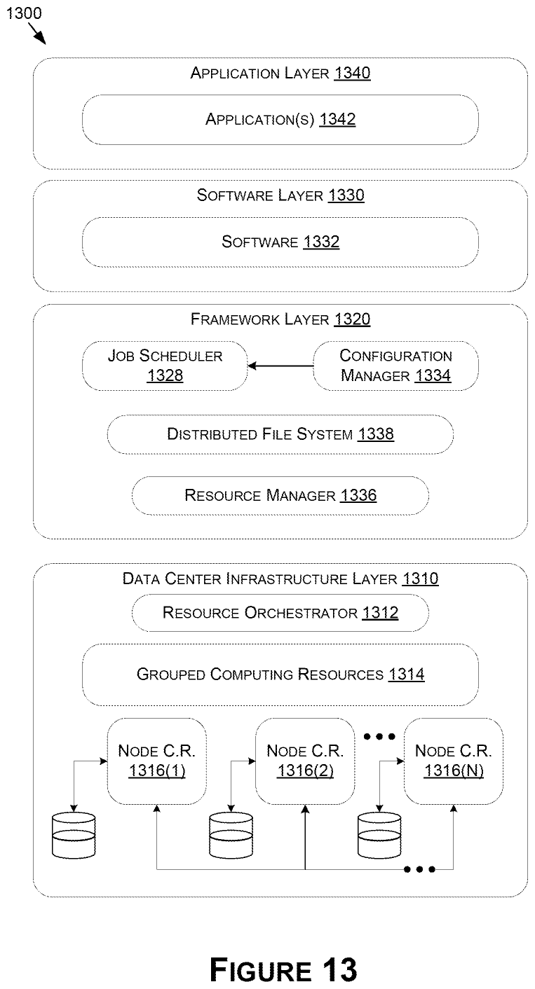

A server(s) 104 may include a communication interface(s) 164, a game service(s) 118, an attestation service(s) 122, a video manager 126, and/or a data store(s) 152. Although only a few components and/or features of the server(s) 104 are illustrated in FIG. 1, this is not intended to be limiting. For example, the server(s) 104 may include additional or alternative components, such as the application server(s) 1102 of FIG. 11, the computing device 1200 of FIG. 12, and/or the data center 1300 of FIG. 13.

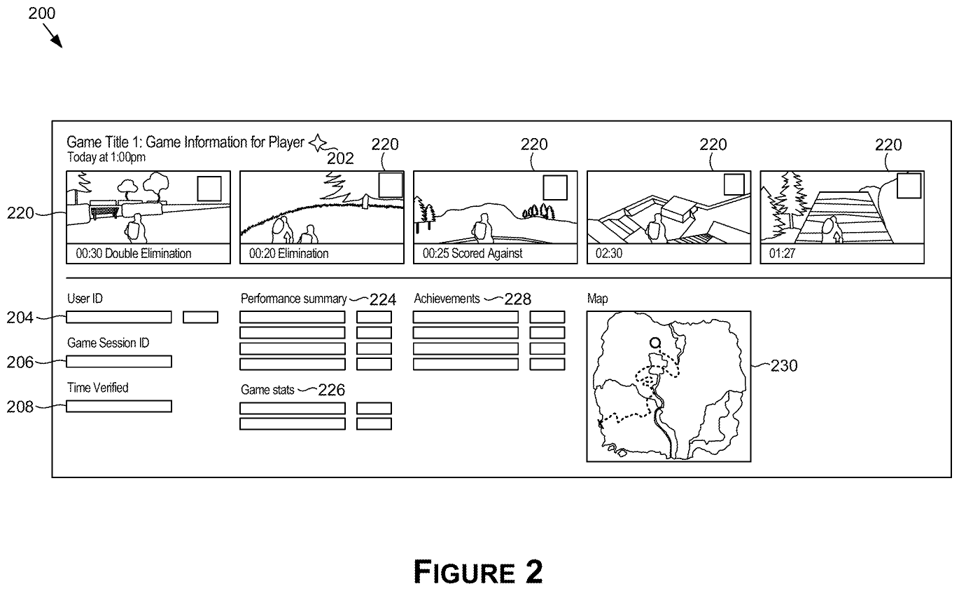

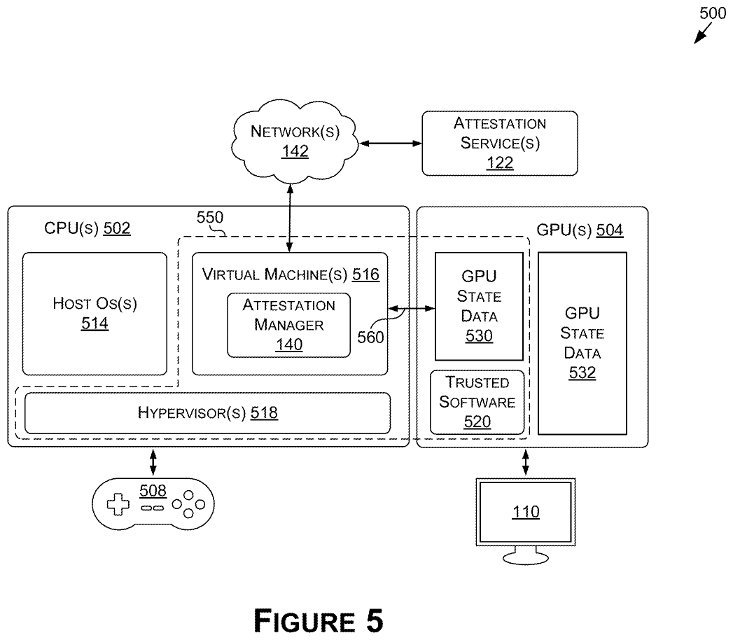

As an overview, a user of a client device(s) 102 may use the gaming application(s) 106 to participate in or attempt to participate in one or more game sessions using one or more execution environments. The attestation manager(s) 140 of the client device(s) 102 may receive one or more attestation reports from one or more trusted components of and/or associated with the client device(s) 102, examples of which are described with respect to FIGS. 5-10, and may use the communication interface 114 to provide data corresponding to the one or more attestation reports to the attestation service(s) 122 of the server(s) 104. The server(s) 104 may receive the data using the communication interface 164 and provide the data to the attestation service(s) 122. The attestation service(s) 122 may verify, using the data, that one or more properties of the one or more execution environments comply with one or more security policies (e.g., stored in the data store 152). The attestation service(s) 122 and/or the game service(s) 118 of the server(s) 104 may associate one or more in-application content items or units (e.g., corresponding to a displayed content item 130D and/or a displayed content item 130G) with the one or more game session, such as the game session 132. The association may indicate the one or more properties of the execution environment(s) comply with the one or more security policies. Based at least on the one or more in-application content items or units being associated with the one or more game sessions, the one or more in-application content items or units may be presented in association with the one or more game sessions (e.g., as indicated in FIGS. 1 and 2).

The game application 106 may be a mobile application, a computer application, a console application, a web application, and/or another type of application. The game application 106 may include instructions that, when executed by a processor(s) of a client device(s) 102, cause the processor(s) to perform one or more operations (such as but not limited to any of the various operations described herein with respect to the system 100). The game application 106 may receive and/or process inputs from one or more of the input devices 108 of the client device(s) 102, and/or cause transmission of input data representative of the inputs to one or more of the server(s) 104, such as a streaming server(s) or a game server(s), a streaming client device(s), and/or one or more other client device(s) 102.

The viewing application 112 may operate as a facilitator for enabling viewing of video of one or more instances of one or more applications or games (e.g., a live stream game video 128 and/or a pre-recorded game video 120). For example, and without limitation, the viewing application 112 may cause display of a live stream of a game instance of a game, such as the live stream game video 128, received from one or more of the servers 104. The viewing application 112 may additionally or alternatively display a pre-recorded stream of a game instance of a game, such as the pre-recorded game video 120, received from the server(s) 104. In one or more embodiments, the viewing application 112 includes a web application, which may operate in a web browser. In one or more embodiments, the viewing application 112 includes a media streaming application. While the client device 102A is shown as including both the viewing application 112 and the gaming application 106, a client device 102 need not include the viewing application 112 and/or the gaming application 106. For example, where the client device 102A is used by an interactive user of the application (e.g., a streamer) to participate in the game session 132, the client device 102A may not include the viewing application 112. Similarly, where the client device 102N is used by a viewer to view the live stream game video 128 or the pre-recorded game video 120, the client device 102N may not include the gaming application 106. Further, the client device 102N may not include one or more other components, such as the attestation manager 140.

Although illustrated as separate application, in one or more embodiments, the game application 106 and the viewing application 112 correspond to a single application. For example, where gameplay and streaming (and/or playback) of gameplay are hosted by a same platform (e.g., NVIDIA's GEFORCE EXPERIENCE), the game application 106 and the viewing application 112 may include a same application. In other embodiments, the game application 106 and the viewing application 112 may be separate applications-even where the gameplay and streaming are hosted by a same platform.

Although the gaming application 106 and the viewing application 112 are described in terms of gaming, in various embodiments, the present disclosure applies to non-gaming applications. Thus, for example, description of a game instance may more generally apply to an application instance and description of a game session may more generally apply to an application session. In one or more embodiments, the application may include a gaming application, a video streaming application, a machine control application, a machine locomotion application, a machine driving application, a synthetic data generation application, a model training application, a perception application, an augmented reality application, a virtual reality application, a mixed reality application, a robotics application, a security and surveillance application, an autonomous or semi-autonomous machine application, a deep learning application, an environment simulation application, a data center processing application, a conversational AI application, a light transport simulation application (e.g., ray tracing, path tracing, etc.), a collaborative content creation application for 3D assets, a digital twin system application, a cloud computing application and/or another type of application or service.

In one or more embodiments, the game application 106 and/or the viewing application 112 may be configured to identify metadata associated with a live stream instance of a game and/or a pre-recorded instance of a game-such as the live stream game video 128 received from the server(s) 104 and/or the pre-recorded game video 120 received from the server(s) 104. For example, with regard to the live stream game video 128, the game application 106 and/or the viewing application 112 may be configured to determine an identifier (e.g., username) of the streamer sharing (e.g., streaming) the live stream, the platform (e.g., digital store) information on which the instance of the game is being played by the streamer, and/or the title of the game. Further, with regard to the pre-recorded game video 120, the game application 106 and/or the viewing application 112 may be configured to determine the platform (e.g., digital store) information on which the instance of the game or application was executed or hosted from, the title of the game or application, and/or any game or application instance identifier information of the game or application (e.g., information associated with specific versions, modifications, user-inventory, life points, weapons-inventory, vehicle, outfit, stats, etc.).

In one or more embodiments, the metadata may identify, indicate, or otherwise correspond to one or more in-application content items or units indicating verification of one or more properties of an execution environment (e.g., corresponding to one or more players or application users, such as the streamer and/or username(s)) used to participate in the one or more application sessions, such as the game session 132. In one or more embodiments, the metadata may identify, indicate, or otherwise correspond to the verification of the one or more properties of the execution environment used to participate in the one or more application sessions, such as the game session 132. By way of example, and not limitation, the metadata may include a link or embedded code of one or more webpages, an example of which includes the webpage 200 of FIG. 2. In one or more embodiments, the metadata may include a link, data store identifier, and/or record identifier of one or more of: a data store including one or more records of the one or more properties being verified, and/or a record of the one or more records. An example of the data store includes one or more of the data stores 152 of FIG. 1. In some embodiments, the game application 106 and/or the viewing application 112 may store the identified metadata in a data store, such as the data store(s) 116, as described herein. In one or more embodiments, the metadata may identify, indicate, or otherwise correspond to one or more display or presentation properties for one or more of the content items. Examples of display or presentation properties include one or more display positions for the one or more in-application content items or units, and/or one or more or more visual characteristics of the one or more in-application content items or units.

The metadata may be received in various ways. In one or more embodiments, a client device 102 may receive at least a portion of the metadata with video data of the pre-recorded game video 120 and/or the live stream game video 128. For example, at least a portion of the metadata may be embedded in a video stream and/or video file. As another example, at least a portion of the metadata may be provided in a sperate stream and/or file.

The display(s) 110 may include any type of display capable of displaying an instance of a game or other application (e.g., a light-emitting diode display (LED), an organic LED display (OLED), a liquid crystal display (LCD), an active matrix OLED display (AMOLED), a quantum dot display (QDD), a plasma display, and/or another type of display). In some examples, depending on the configuration of the client device(s) 102, the display 110 may include more than one display (e.g., a dual-monitor display for computer gaming, a first display for configuring a game and a virtual reality display for playing the game, etc.), may include a display of an augmented reality (AR) or virtual reality (VR) system, and/or may include another number or type of display. Where the display 110 is a touch-screen display, such as a touch-screen of a smart phone, tablet computer, laptop computer, and/or the like, the display 110 may correspond to at least one of the input device(s) 508 of the client device(s) 102 (e.g., one of the input device(s) 508 for generating inputs to an instance of the game, such as for transmission to a viewing application 112, a server(s) 104, and/or one or more other client device(s) 102). Where embodiments are implemented at least partially as a gaming application, a display 110 may display a game stream, such as the live stream game video 128 and/or the pre-recorded game video 120 of one or more game sessions, such as the game session 132. The game session 132 may include any number of game sessions participated in by one or more users (e.g., a streamer) of one or more of the client devices 102.

The display 110 may display an instance(s) of a game(s) during gameplay, and/or may display a stream and/or recording of a game instance (e.g., of another player playing the game, such as a streamer). The game session 132 is an example of such a display and may correspond to the live stream game video 128 and/or the pre-recorded game video 120. The visualization of the game session 132 in FIG. 1 may correspond to, without limitation, a visualization of a game session participated in by a user (e.g., streamer) of the client device 102A, by a user (e.g., viewer) of client device 102N, by both a streamer and a viewer of the game session 132, by users (e.g., viewers) of other client device(s) 102, and/or a combination thereof.

The game session 132 may include game session data (e.g., game state data). The game session data may represent a current state of the game, including game statistics, object states, inventories, health information, player locations, indication(s) of verification(s) of one or more properties of an execution environment(s) of one or more players, achievement progress, modifications, and/or other information about players, game information, and/or environment features (e.g., a location of “Player 1”, a state of building, attributes of a cliff, current items inventory, score information, player information, etc.). In one or more embodiments, any combination of this information may be included in or otherwise correspond to the metadata described with respect to the live stream game video 128 and/or the pre-recorded stream game video 120.

The game session 132 or display thereof within the game application 106 and/or the viewing application 112, may include graphical elements. One or more of the graphical elements may be included in the game session 132, rendered as part of output frames of the game session 132, rendered as overlays to video data corresponding to the output frames of the game session 132, and/or displayed with the video data corresponding to the output frames of the game session 132 (e.g., alongside).

Non-limiting examples of the graphical elements include a player window 160, a chat region 134, chat messages 144A and 144B, and displayed content items 130A, 130B, 130C, 130D, 130E, 130F, and 130G (also referred to as “displayed content items 130”). As illustrated in FIG. 1, the player window 160 may depict a visual representation of the user (e.g., a player, such as a streamer) on the client device 102A playing an instance of a game that is displayed to a user (e.g., a viewer) of the client device 102N. For example, the player window 160 may include a video 162 (e.g., a live stream) of the user. The video 162 may be included in the live stream game video 128 or the pre-recorded game video 120 or included in a separate video (e.g., which may be composited with and/or played with the live stream game video 128 or the pre-recorded game video 120).

Examples of in-application content items or units corresponding to the displayed content items 130 include one or more of one or more visual tokens (e.g., badges, icons, models, etc.), in-game content (e.g., a specific character or object visualization know as a “skin,” an in-game item, a colorway, a special effect, a 3D model, a character, and/or a content variant), and/or links to the one or more webpages.

In-application content items or units, such as (without limitation) tokens, models, and/or in-game items, may take different forms of a visual representation positioned as defined by the game instance, the game application 106 and/or the viewing application 112. In one or more embodiments, an in-application content item or unit may be positioned based at least on the user the unit or item is associated with to indicate verification for that user (e.g., positioned to indicate the unit or item corresponds to that user). For example, the content item 130A may be positioned to indicate an association with player 1, the content item 130B may be positioned to indicate an association with player 2, the content item 130C may be positioned to indicate an association with player 3, the content item 130E may be positioned to indicate an association with user_123, the content item 130F may be positioned to indicate an association with user_ABC, etc. The content item 130G may be an example on an in-game content item, which may be displayed in association with a player character. For example, a unit of in-application content or content item may be displayed in association with a player character and/or another user character based at least on being associated with that user. Thus, a viewer of the display of the game session 132 may readily identify which users have been verified. In one or more embodiments, a lack of a content item associated with a user may indicate the user has not been verified and/or the user has failed verification. In one or more embodiments, a different unit of in-application content or content item(s) may be associated with and displayed for user's that have not been verified and/or have failed verification than a user(s) that have been verified.

In one or more embodiments, in-application content items or units (collectively, “content items”) indicating verification for an execution environment may be visually the same across all verified users, or the content items may vary. In at least one embodiment, at least a set or class of the in-application content items or units may visually adhere a same template, but with a distinct, embedded code or link, which leads to a page showing player information for the associated user (e.g., a game service page of the game service 118). In at least one embodiment, at least a set or class of the content items may be visually unique across one or more verified session participants (e.g., all verified players). In one or more embodiments, uniqueness and/or randomness for the visual appearance of a content item may originate from the game service 118 and/or the attestation service 122. In one or more embodiments, the uniqueness and/or randomness may be based at least on the one or more properties of the execution environment (e.g., the attestation service 122 and/or the game service 118 may use a random seed that is defined by the properties to determine one or more aspects of the visual appearance). In one or more embodiments, at least a set or class of the content items may be visually unique and/or customizable by the user. For example, a user may design the visual appearance of a content item using a template. In one or more embodiments, the template may include with one or more placeholders for embedding unique and/or customizable visual properties. In at least one embodiment, the visual properties may be generated by the game service 118 and/or the attestation service 122. In one or more embodiments, an in-application content unit or item may be used to indicate verification for a user for multiple games and/or game sessions or instances. In one or more embodiments, one or more visual properties for in-application content items or units may be used to visually identify a user and/or groups of users (e.g., a team) across multiple gaming sessions, teams, tournaments, sponsored colors/patterns, etc.

The input device(s) 508 may include any type of device capable of providing user inputs to a game and/or a client device 102. The input device(s) 508 may include a keyboard, a mouse, a joystick, a touch-screen display, a controller(s), a remote(s), a headset (e.g., sensors of an AR or VR headset), a video camera, a microphone, another type of input device, and/or a combination thereof.

The communication interface 114 may include one or more components and features for communicating across one or more networks, such as the network(s) 142. The communication interface 114 may be configured to communicate via any number of network(s) 142, described herein. For example, to communicate in the system 100 of FIG. 1, the client device 102A may use an Ethernet or Wi-Fi connection through a router to access the Internet in order to communicate with the server(s) 104, the client device(s) 102N, and/or another client device(s) 102.

The data store(s) 116 may include any memory device type(s). In embodiments where the game session 132 is received as a live stream, such as the live stream game video 128, the data store(s) 116 may be tasked with the storage of metadata associated with the live stream game video 128 identified by one or more components of client device(s) 102A, such as the game application 106 and/or the viewing application 112. In one or more embodiments, the viewing application 112 and/or the game application 106 may use the metadata to display and/or present one or more of the content items 130 in accordance with the metadata. For example, the content items 130 may be presented at positions indicated by the metadata, may be presented using one or more visual properties indicated by the metadata, may be presented with one or more embedded links indicated by the metadata, may be presented in association with one or more users indicated by the metadata, etc.

The communication interface(s) 164 of the server(s) 104 may include one or more components and features for communicating across one or more networks, such as the network(s) 142. The communication interface 164 may be configured to communicate via any number of networks 142, described herein.

The data store(s) 152 of the server(s) 104 may include any memory device type(s). The data store(s) 152 may be tasked with the storage of metadata associated with the live stream game video 128 and/or the pre-recorded game video 120. The metadata may include any combination of the various metadata described herein. The metadata may be generated, at least in part, by and/or using the game server(s) 118, the attestation service(s) 122, and/or other services.

In one or more embodiments, the server(s) 104 may include one or more game servers, such as one or more servers (e.g., dedicated game servers) for storing, hosting, managing, and, in some examples, rendering a game. The game server(s) may be used to create, update, and/or modify a game (e.g., the program code of the game), as well as to host the game (e.g., as dedicated game servers). In one or more embodiments, the game server(s) may include additional or alternative components, such as those described below with respect to the application server(s) 1102 of FIG. 11 and/or the computing device 1200 of FIG. 12.

The game server(s) may include one or more APIs to enable gameplay by the client device(s) 102, and/or to enable communication of information (e.g., metadata, game session data, etc.) with one or more other server(s) 104 (e.g., streaming servers). For example, a game server(s) may include one or more game APIs that interface with the game application 106 of the client devices 102 to enable gameplay by the client devices 102. As a further example, the game server(s) may include one or more game session APIs that interface to pass game session data and/or metadata to a streaming server(s) of the servers 104. APIs described herein may be part of a single API, two or more APIs, different APIs other than those described as examples herein, or a combination thereof. While streaming servers and game servers are described, in at least one embodiment, a single server and/or group of servers may include at least a portion of the functionality of a game server and/or a streaming server.

The game service(s) 118 may include the functionality that enables a game(s) to be played by one or more users (e.g., players, streamers, viewers, etc.) over a network, such as the network(s) 142. A game service 118 may include a rendering engine, an audio engine, a physics engine, an animation engine, an artificial intelligence engine, a networking engine, a streaming engine, a memory management engine, and/or other components or features. A game service 118 may be used to generate some or all of the game session data (e.g., metadata) during, prior to, and/or after a game session. In one or more embodiments, a game service 118 may include and/or use an attestation service(s) 122.

A streaming server(s) 104 may include one or more servers. Streaming server(s) may include, without limitation, dedicated streaming servers for storing, hosting, managing, provisioning (e.g., from a cloud computing ecosystem) and, in some examples, rendering an instance of an application or game (e.g., where a stream is generated from game state data corresponding to a game). In some examples, different streaming server(s) 104 may be used for managing live streams than for managing pre-recorded streams, while in other examples, any streaming server 104 may handle both live streams and pre-recorded streams. The streaming server(s) 104 may further include a communication interface 164 similar to communication interface 114 of client device(s) 102A, a video manager 126, and a data store(s) 152 similar to the data store(s) 116 of client device(s) 102A. Although only a few components and/or features of the streaming server(s) 104 are illustrated in FIG. 1A, this is not intended to be limiting. For example, the streaming server(s) 104 may include additional or alternative components, such as those described below with respect to the computing device 1200 of FIG. 12.

Where the server(s) 104 includes one or more streaming servers, the streaming server(s) may include one or more APIs to generate and/or transmit a stream(s) of the live stream game video 128 and/or the pre-recorded game video 120 (e.g., metadata, game session data, video data, etc.) to, between, and/or among any combination of the game server(s) and/or the client devices 102. For example, a streaming server(s) may include one or more APIs that interface with the game application(s) 106 and/or the viewing application(s) 112 of the client devices 102, the attestation service 122, and/or the game service 118 (or other components) to enable receipt of, generation of, and/or transmission of a stream of a game instance.

The video manager 126 may be configured to manage any number of videos generated during one or more instances of one or more games, such as the live stream game video(s) 128 and/or pre-recorded game video(s) 120. For example, a user (e.g., streamer) may be playing an instance of a game on the client device(s) 102A. The instance of the game may be rendered at the server(s) 104 (e.g., a game server thereof) and/or at the client device(s) 102A. The player may wish to live stream the instance of the game and/or another user may wish to view a live stream of the game. As such, the video manager 126 may be configured to manage the live stream (e.g., the live stream game video 128), and transmit the live stream game video 128, including associated metadata, to the client device(s) 102N. Additionally, or alternatively, a user (e.g., streamer) may be playing an instance of a game on the client device(s) 102A. The instance of the game may be rendered at the server(s) 104 and displayed on the display 110 of the client device(s) 102A. The player may wish to record and/or share a video of the instance of the game for later viewing and/or streaming to other users (e.g., viewers). As such, the server(s) 104 may be configured to manage the pre-recorded game video (e.g., the pre-recorded game video 120), and transmit the pre-recorded game video 120, including associated metadata, to the client device(s) 102N.

The attestation manager(s) 140 (e.g., running on the client device 102A) may receive one or more attestation reports from one or more trusted entities (e.g., hardware and/or software entities). The attestation manager(s) 140 may provide data, using the network(s) 142, corresponding to the one or more attestation reports to the attestation service(s) 122. The attestation service 122 may verify the data indicates one or more properties of one or more execution environments (e.g., a trusted computing base) associated with the game session 132 and/or the gaming application 106. For example, the one or more execution environments may be implemented and/or used for participating in one or more game sessions, such as the game session 132 (more generally an application session). The attestation service 122 may generate data (e.g., using the network(s) 142) indicating the verification.

The execution environment that is verified may include any execution environment used to participate in a game session. For example, an execution environment may include the execution environment through which at least a portion of the game application(s) 106 is executed, such as a game executable. Additionally, or alternatively, the execution environment may include an execution environment which provides user inputs to the game session or otherwise provides user input associated with the game session and/or video thereof. Examples of such execution environments includes an execution environment of an input device, such as any of the various input devices described with respect to an input device(s) 508 of FIG. 5 (e.g., a controller, keyboard, mouse, and/or microphone used to provide user input to the game session 132, a video camera use used to generate video data for the player window 160, etc.).

The data may cause the server(s) 104, the client device 102A, the client device 102N, the game server 118, the attestation service 122, and/or one or more applications or services to perform one or more operations. For example, the attestation service(s) 122 and/or the game service(s) 118 of the server(s) 104 may associate one or more of the content items 130 with the one or more game session, such as the game session 132. The associating may indicate the one or more properties of the execution environment(s) comply with the one or more security policies. The one or more properties may include, for example, any combination of the various properties describes with respect to FIGS. 5-8. FIGS. 5-8 provide examples of aspects which may be incorporated into the system 100 but are not intended to be limiting. For example, while FIGS. 5-8 are described with respect to a trusted computing base (TCB), the one or more properties may generalize to any form of execution environment(s). Further, while FIGS. 5-8 are described with respect to various computing architectures, the client device(s) 102 is not limited to those architectures. As an example, a VM 516 and/or GPU 504 may not be included in some embodiments. Further, while attestation has been described for verifying one or more properties of one or more execution environments, one or more embodiments may use different verification technologies to verify the one or more properties.

In at least one embodiment, the associating may include generating and/or transmitting data indicating the one or more properties have been verified (e.g., for a particular game session or game sessions). For example, the data may include at least a portion of the metadata described herein, and/or data corresponding to the metadata. Additionally, or alternatively, associating the one or more game sessions and/or one or more content items with one or more records in a data store (e.g., a database), such as the data store 152. For example, the one or more records and/or other data may indicate the one or more properties have been verified (e.g., for a particular game session or game sessions). In at least one embodiment, the data may identify one or more content items corresponding to the verification. For example, the data may include one or more content item identifiers and/or may be used to determine one or more associated in-application content items or units (e.g., the data may indicate a level or type or verification or other property which may correspond to a particular content item, content unit, or class of content item or content unit).

In one or more embodiments, the records and/or other data corresponding to the verification may be accessed to determine what and/or whether to display one or more of the in-application content items or units in association with the user and/or game session. For example, the game service 118, the video manager 126, the viewing application 112, and/or the gaming application 106 may use the data for the display of one or more of the content items 130. Additionally, or alternatively, the data may be accessed other users, services, or applications to determine what users and/or game sessions have been verified and/or what in-application content unit(s) or item(s) is associated with the user and/or game session. For example, the data may be accessible via queries regarding any aspect of verification. In at least one embodiment, the data may be open to public queries before, during, and/or after corresponding game sessions. While display of the content items 130 in association with the game session 132, such as in FIG. 1, may be a strong indication that a verification has occurred and a player is not cheating, allowing other users to access the database may protect against spoofing of content items.

In one or more embodiments, a link or other indicator of the database and/or record of verification may be provided in association with the corresponding game session(s) and/or content item(s). For example, as described, in one or more embodiments the metadata may include or indicate a link or embedded code herein corresponding to the database and/or record. In one or more embodiments, the link or embedded code may correspond to one or more webpages, which may be used to view and/or access the data corresponding to the verification(s). Referring now to FIG. 2, FIG. 2 illustrates an example of a webpage 200 displaying verification information in association with one or more content items signifying verification of a player's gaming system, in accordance with some embodiments of the present disclosure.

The webpage 200 includes a content item 202 displayed in association with a corresponding game session, such as the game session 132, which may be similar to the content items 130 of FIG. 1. At least some of the information populating the webpage 200 may correspond to the data corresponding to the verification(s) for the game session 132 (e.g., retrieved from a record). In at least one embodiment, the information may include the content item 202, a user ID 204 corresponding to the verification, a game session ID 206 corresponding to the verification, and a time 208 corresponding to the verification. The webpage 200 may be populated and/or displayed, at least in part, prior to, during, and/or after the corresponding game session. In at least one embodiment, the webpage 200 may include other information, such as game summary information for the game session. Examples include links to one or more video clips 220 of the game session, a performance summary 224, game statistics 226, game achievements 228, and a game map 230. However, the webpage 200 may take many different forms and may include many different types of information.

Game streaming, video streaming, and cloud and/or server-based embodiments are described herein. Aspects of the present disclosure may be implemented for non-cloud or service-based games, such as local games running on the client device 102A. For example, at least some of the functionality and/or components of the server(s) 104 may be included in the client device 102A. By way of example, and not limitation, the attestation service(s) 122, the video manager(s) 126, and/or the game service(s) 118 may be included in one or more of the client devices 102. In one or more embodiments, any combination of these various components may be included in a trusted execution environment of a client device 102 (e.g., within the same or a different execution environment that the execution environment used to participate in the gaming session).

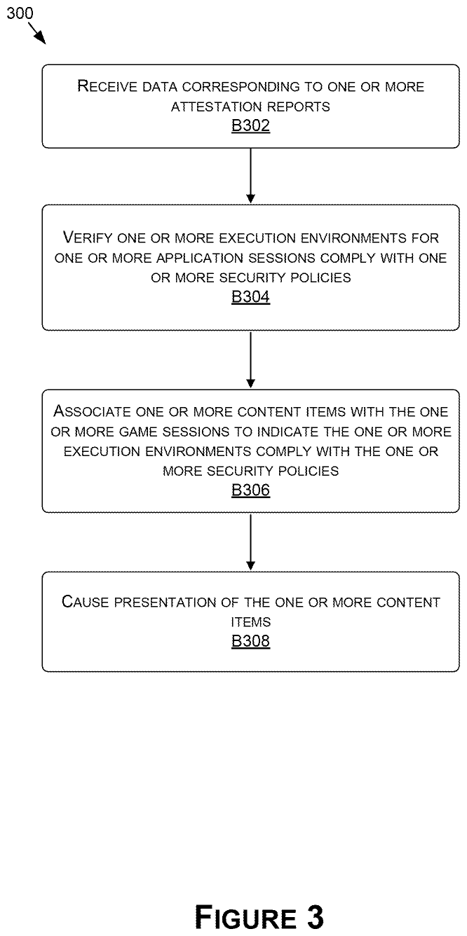

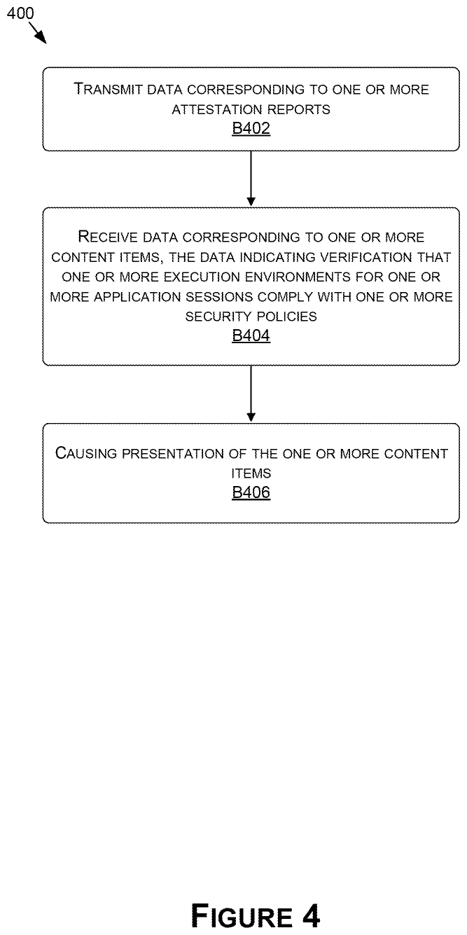

Now referring to FIGS. 3-4, each block of method 300, and 400, and other methods described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, methods are described, by way of example, with respect to particular figures. However, the methods may additionally or alternatively be executed by any one system, or any combination of systems, including, but not limited to, those described herein.

Referring now to FIG. 3, FIG. 3 shows a flow diagram showing a method 300 which may be used to associate a content item with a game session, in accordance with some embodiments of the present disclosure. The method 300, at block B302, includes receiving data corresponding to one or more attestation reports. For example, the attestation manager(s) 140 may receive data corresponding to one or more attestation reports generated using the client device(s) 102A. The one or more attestation reports may indicate one or more properties of one or more execution environments for participating in one or more game sessions, such as the game session 132.

At block B304, the method 300 includes verifying one or more execution environments for one or more application sessions comply with one or more security policies. For example, the attestation service(s) 122 may verify, using the data, that the one or more properties of the one or more execution environments comply with one or more security policies.

At block B306, the method 300 includes associating one or more in-application content items or units with one or more game sessions to indicate the one or more execution environments comply with the one or more security policies. For example, the attestation service(s) 122 and/or the game service(s) 118 may associate one or more of the content items 130 with the one or more game sessions. The associating may indicate the one or more properties comply with the one or more security policies.

At block B308, the method 300 includes causing presentation of the one or more in-application content items or units. For example, the attestation service(s) 122 and/or the game service(s) 118 may, based at least on the one or more of the content items 130 being associated with the one or more game sessions, cause, using data, presentation of the one or more of the content items 130 (e.g., on the display 110).

Referring now to FIG. 4, FIG. 4 is a flow diagram showing a method 400 which may be used to present in-application content items or units with a game session, in accordance with some embodiments of the present disclosure. The method 400, at block B402, includes transmitting first data corresponding to one or more attestation reports. For example, the client device 102A may transmit first data corresponding to one or more attestation reports generated using the client device 102A. The one or more attestation reports may indicate one or more properties of an execution environment for participating in one or more application sessions, such as the game session 132.

At block B404, the method 400 includes receiving data corresponding to one or more content items, the data indicating verification that one or more execution environments for one or more application sessions comply with one or more security policies. For example, a client device(s) 102 may receive second data corresponding to one or more of the content items 130. The second data may indicate verification, using the first data, that the one or more properties of the execution environment comply with one or more security policies. The data may include, for example, one or more portions of the metadata for the game session 132, the live stream game video(s) 128 for the game session 132, the pre-recorded game video(s) 120, and/or other data.

At block B406, the method 400 includes causing presentation of the one or more content items. For example, the client device(s) 102 may cause presentation of the one or more of the content items 130 in association with the one or more application sessions. For example, a content item 130 may be presented as in FIGS. 1 and/or 2.

### Examples of a Trust Verification System

Referring now to FIG. 5, FIG. 5 depicts an example of a trust verification system 500 (also referred to as “system 500”) which may be used to implement the gaming verification system 100 of FIG. 1, in accordance with some embodiments of the present disclosure.

The system 500 may be implemented using, among additional or alternative components, one or more CPUs, such a CPU(s) 502, one or more GPUs, such as a GPU(s) 504, one or more networks, such as the network(s) 142, one or more peripheral devices, such as an input device(s) 508, and/or one or more displays, such as the display(s) 110. The CPU(s) 502 may run one or more host OSs, such as a Host OS(s) 514, one or more virtual machines, such as a virtual machine(s) 516, and one or more hypervisors, such as a hypervisor(s) 518. The GPU(s) 504 may run trusted software, such as trusted software 520 and manage GPU state data, such as GPU state data 530 and GPU state data 532.

As an overview, the attestation manager(s) 140 (e.g., running on the VM 516) may receive one or more attestation reports from the CPU 502 and the GPU 504. For example, the CPU 502 may generate at least one attestation report and provide the attestation report(s) to the attestation manager 140 (e.g., using a hypervisor 518). Further, the GPU 504 may generate at least one attestation report and provide the attestation report(s) to the attestation manager 140 (e.g., using the hypervisor 518 and the trusted software 520). The attestation manager(s) 140 may provide data, using the network(s) 142, corresponding to the one or more attestation reports to an attestation service(s) 122. The attestation service 122 may verify the data indicates one or more properties of a TCB 550. For example, the attestation service 122 may verify the data indicates the TCB 550 is to include the VM 516 and the GPU state data 530 (that the VM 516 may use to perform one or more operations). The attestation service 122 may further verify TCB 550 is to isolate the VM 516 and the GPU state data 530 from the host OS 514. For example, the attestation service 122 may verify the TCB is to further include the hypervisor 518 to facilitate at least some of the isolation. The attestation service 122 may provide data, using the network(s) 142, indicating the TCB 550 has been verified. The data may cause the VM 516 and/or one or more applications or services external to the VM 516 to perform one or more operations. For example, the data may enable the VM 516 to use the GPU state data 530 to participate in an application session, such as an online multiplayer gaming session (e.g., the game session 132), or otherwise impact operations of the VM 516 and/or one or more applications or services external to the VM 516 (e.g., a game server).

The TCB 550 is an example of an execution environment which may be verified for the game session 132 of FIG. 1. The CPU(s) 502 and the GPU(s) 504 may be implemented on one or more host systems, such as one or more host devices. In one or more embodiments, one or more of the CPUs 502 and/or the GPUs 504 may be included in a client device 102 of FIG. 1. Examples of a host system include one or more of a personal computer (PC), a smart phone, a laptop computer, a tablet computer, a desktop computer, a wearable device, a smart watch, a mobile device, a touch-screen device, a game console, a virtual reality system (e.g., a headset, a computer, a game console, remote(s), controller(s), and/or other components), a streaming device, (e.g., an NVIDIA SHIELD), a smart-home device that may include an intelligent personal assistant, a server, a data center, a Personal Digital Assistant (PDA), an MP3 player, a virtual reality headset, a Global Positioning System (GPS) or device, a video player, a video camera, a surveillance device or system, a vehicle, a boat, a flying vessel, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device. In at least one embodiment, the CPU 502 and the GPU 504 may be included in one or more of the client devices 1104 of FIG. 11 or the application server(s) 1102 of FIG. 11. In at least one embodiment, the CPU 502 and/or the GPU 504 may be included in the data center 1300 of FIG. 13.

As shown in FIG. 5, the attestation manager 140 may be included in the VM(s) 516. As further examples, the attestation manager 140 may be included, at least in part, in one or more other VMs, software components, and/or devices, such as a different VM or trusted software or other component (e.g., in the trusted software 520 and/or other trusted software). To enable policy enforcement and/or remote verification, the VM(s) 516 and/or other components of the system 100 may use, by way of example and not limitation, one or more of system guard runtime monitor (SGRM), secure boot, virtualization-based security (VBS), dynamic root of trust for measurement (DRTM), or device guard.

The attestation service 122 may be implemented in the same, similar, or different systems than the CPU(s) 502 and the GPU(s) 504. While the attestation service 122 is shown as communicating to the VM 516 over the network 142, in at least one embodiment, the attestation service 122 may be implemented in one or more host systems or devices that include the CPU(s) 502 and the GPU(s) 504. Thus, while the attestation service 122 is shown in FIG. 1 as communicating with the VM 516 and/or the attestation manager 140 over the network(s) 142, in at least one embodiment, different communication media and/or interfaces may be used. In at least one embodiment, the attestation service 122 is included in one or more servers (e.g., the server 104 of FIG. 1). For example, the attestation service 122 may be included in the application server(s) 1102 of FIG. 11, one or more game servers, and/or one or more different servers.

As described herein, the VM 516 may use the GPU state data 530 to perform one or more operations. For example, the VM 516 may communicate with the GPU 504 over one or more communication channels 560 to perform one or more operations. GPU state data may refer to data representing one or more variables, conditions, parameters, resources, device code, and/or other data used to perform one or more tasks using the GPU(s) 504, such as one or more parallel processing tasks. Examples of the parallel processing tasks include tasks to implement one or more portions of the one or more operations, such as one or more operations for gaming, machine control, machine locomotion, machine driving, synthetic data generation, model training, perception, augmented reality, virtual reality, mixed reality, robotics, security and surveillance, autonomous or semi-autonomous machine applications, deep learning, environment simulation, data center processing, conversational AI, light transport simulation (e.g., ray tracing, path tracing, etc.), collaborative content creation for 3D assets, digital twin systems, cloud computing and/or any other suitable applications.

Examples of the resources include objects such as modules and texture or surface references. A module may refer to a dynamically loadable package of device code and/or data. Device code symbols may include functions, global variables, and/or texture, surface, and/or resource references. In at least one embodiment, each set of GPU state data may have its own distinct address space, and values from the set of GPU state data may reference corresponding memory locations. In one or more embodiments, a set of GPU state data, such as the GPU state data 530, may include a GPU context, such as a compute unified device architecture (CUDA) context.

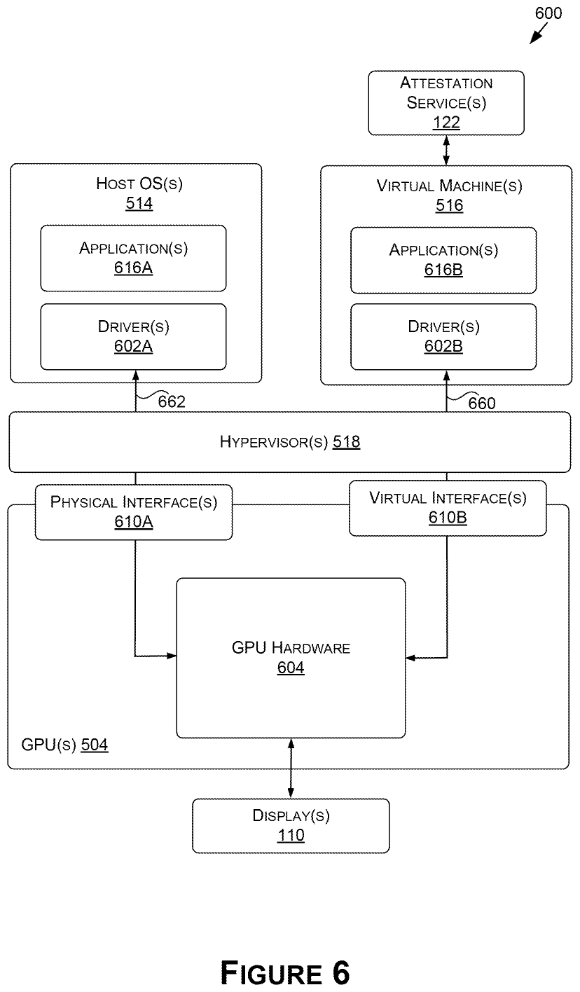

In one or more embodiments, the one or more operations may be performed, at least in part, using one or more applications running on the VM 516. The application(s) may include, for example, an application(s) 616B of FIG. 6. The application 616B may include a game, a video streaming application, a machine control application, a machine locomotion application, a machine driving application, a synthetic data generation application, a model training application, a perception application, an augmented reality application, a virtual reality application, a mixed reality application, a robotics application, a security and surveillance application, an autonomous or semi-autonomous machine application, a deep learning application, an environment simulation application, a data center processing application, a conversational AI application, a light transport simulation application (e.g., ray tracing, path tracing, etc.), a collaborative content creation application for 3D assets, a digital twin system application, a cloud computing application and/or another type of application or service.

The application 616B may include a mobile application, a computer application, a console application, a tablet application, and/or another type of application. The application 616B may include instructions that, when executed by a processor(s) (e.g., the CPU 502 and/or the GPU 504), cause the processor(s) to, without limitation, configure, modify, update, transmit, process, and/or operate on the GPU state data 530, receive input data representative of user inputs to the one or more input device(s) (e.g., corresponding to the input device 508), transmit at least some of the input data to a server(s) (e.g., an application server 1102 and/or a game server), retrieve at least a portion of application data from memory, receive at least a portion of application data from the server(s), and/or cause display of data (e.g., image and/or video data) corresponding to the GPU state data 530 on the display 110. In one or more embodiments, the application(s) 616B may operate as a facilitator for enabling interacting with and viewing output from an application instance hosted on an application server using a client device(s).

In one or more embodiments, the application 616B includes the gaming application(s) 106 and/or the viewing application(s) 112 of FIG. 1. In one or more embodiments, the VM 516 and/or application 616B receives display data (e.g., encoded display data, as described with respect to FIG. 11), and uses the GPU state data 530 to decode, render, and/or display image frames corresponding to the application instance on the display(s) 110. In some examples, a first client device 102 may render image frames while a second client device 102, may receive the display data and display the image frames using the display data. In examples where the display data is received by the VM 516 (e.g., where the CPU 502 and the GPU 504 do not generate the rendering), the architecture 600 be used to implement a game streaming system, such as the content streaming system 1100 of FIG. 11, described herein. The VM 516 and/or the application 616B may facilitate a plurality of game or application sessions over time. The application sessions may include any number of application sessions participated in by any number of users for any number of different applications.

The input device(s) 508 may include any type of input device capable of providing user inputs to the VM(s) 516, the host OS(s) 514, and/or the application(s) 616B (e.g., the input device(s) 1126 of FIG. 11). The input device(s) 508 may include one or more of a keyboard, a mouse, a microphone(s), a touch-screen display, a controller(s), a remote(s), a headset (e.g., sensors of a virtual reality headset), and/or other types of input devices. In one or more embodiments, the user inputs may be used to control one or more application instances running locally on the VM(s) 516 or other competent of the one or more host systems and/or remotely on an application and/or game server, such as the application server(s) 1102 of FIG. 11. In one or more embodiments, the VM(s) 516 may include a game and/or video streaming application, and/or another type of application or service. For example, where an application instance is running remotely, the VM(s) 516 may receive streaming video data corresponding to output frames from an application instance running on a server, present the video data using the display 110 and the GPU state data 530, and stream the user input data to the server to control the application instance.

As described herein, the attestation service 122 may verify the data indicates one or more properties of the TCB 550 (or more generally an execution environment). For example, the attestation service 122 may track valid software and/or hardware configurations for the TCB 550 that include the one or more properties. By verifying the properties of the TCB 550, the VM 516, the application 616B, an application server, and/or other devices, components, or entities may determine whether the TCB 550 is to operate in accordance with security policies and/or enforce those security policies. For example, one or more entities may determine the VM 516 is operating in environment that is architecturally isolated from one or more cheat vectors for gaming or otherwise one or more attack vectors for application usage. Thus, in at least one embodiment, the attestation service 122 is used to reduce the impact and/or frequency of cheating in gaming, even where the host OS(s) 514 corresponds to an open system, for example, on a PC.

For example, the TCB 550 may be verified to enable the VM 516 to use the GPU state data 530 to participate in an application session, such as an online multiplayer gaming session, or otherwise impact operations of the VM 516 and/or one or more applications or services external to the VM 516 (e.g., a game server). In one or more embodiments, the system 100 may be integrated into a multiplayer gaming architecture in which multiple users (e.g., players) connect to a game service that hosts game sessions over the internet (e.g., the game session 132). In one or more embodiments, the game service (e.g., the game service 118) may use the attestation service 122 to determine whether to admit a user into a game based at least on one or more properties of the TCB(s) indicated by attestation report(s). For example, the game service may determine whether to: allow a user to connect to the game service, enter a specific game session, enter a type of game session, etc. In one or more embodiments, the game service may determine whether to associate one or more of the content items 130 with the game session 132 and/or what content items 130 to associate with the game session 132 based at least on one or more properties of the TCB(s) indicated by attestation report(s).

The action(s) taken by the game service based on results of the attestation service 122 analyzing the data indicating the properties of the TCB(s) may be defined by policy information, which may be configured by a game service operator (e.g., a user having an authorized user group type). In at least one embodiment, the policies may define one or more minimum or maximum hardware and/or software requirements (e.g., for admission to the game). If software or hardware that gives an unfair advantage to a player is detected on the system 100 using the attestation service 122, the game service may prevent the user from joining or continuing to use game service and/or from being verified (e.g., for a particular content item(s) 130).

While connected to the game service, the system 100 may provide one or more attestation reports to the attestation service 122 for verification (e.g., re-verification) when requested. When connected to the game service, the user may still be able to use the system 500 for other purposes (e.g., outside of the TCB 550) simultaneously with using the application(s) 616B on the game service. For example, in at least one embodiment, the host OS 514 and/or another VM or service outside of the TCB 550 may operate using GPU state data 532 that is outside of the TCB 550. By way of example, and not limitation, the host OS 514 may use the GPU state data 532 to render one or more portions of a host OS desktop, to render graphical content of one or more applications running on the host OS 514, or to otherwise perform one or more options using the GPU 504. The game service and/or attestation service 122 may detect spoofing of and/or tampering associated with attestation reports and act against entities and/or systems associated with the spoofing (e.g., by issuing and enforcing bans). In one or more embodiments, the game service may authenticate a user prior to accepting and/or acting in association with data corresponding to one or more attestation reports from the user.

Thus, results of the attestation service 122 analyzing the data corresponding to the attestation report(s) may be used by an application service (e.g., the game service 118) to enable the VM 516 and/or the application 616B to perform one or more operations, such as participating in an application session, connecting to an application server and/or service, operating using the GPU state data 530, etc. Additionally, or alternatively, the results may be used to verify the authenticity of data generated based at least on execution of the application(s) 616B and/or VM(s) 516, such as results, output data, recordings, and/or other content generated using the TCB 550 (e.g., to authenticate gameplay to verify a speed run, verify achievements, authenticate, or verify neural network output data, etc.). Disclosed approaches may be used to, for example, guarantee that pixels (e.g., for the display 110) or other data generated using the system 500 were not altered or generated by untrusted hardware and/or software. In one or more embodiments, one or more of the verifications may be indicated based at least on associating the game session(s) with one or more of the content items 130, as described herein.

As indicated herein, disclosed approaches are not limited to server-based implementations. For example, the VM(s) 516 and/or the application(s) 616B may perform one or more actions and/or operations based at least on the results without requiring a corresponding determination at a server.

As described herein, the verified properties for the TCB 550 may include that the TCB 550 is to include the GPU state data 530 and the VM 516 and that the TCB 550 is to isolate the GPU state data 530 and the VM 516 from the host OS 514, which may be untrusted. In doing so, the VM 516 may operate in a trusted environment using trusted code that is protected from most known significant attack vectors related to the host OS 514 while using the GPU state data 530. Thus, the VM 516 may benefit from GPU acceleration and/or other functionality of the GPU 504, while being protected from the host OS 514. For example, the host OS 514 may be operating in an open system or may otherwise be vulnerable to execution of unauthorized or untrusted code, such as cheat software, whether or not the untrusted code is installed and/or run intentionally by a user of the host OS 514. However, the TCB 550 may ensure the integrity of the VM 516, and associated data generated using the GPU 504 by preventing the host OS 514 from accessing memory and one or more communications channels used by the VM 516 to perform computing operations using the GPU state data 530.

As described herein, aspects of the disclosure provide approaches for a TCB to architecturally isolate the VM 516 and the GPU state data 530 from the host OS 514 based at least on including the hypervisor 518 within the TCB 550 (e.g., regardless of features related to attestation reports and/or verification of properties of the TCB 550). Thus, in one or more embodiments, the attestation service 122 may verify the TCB 550 includes the hypervisor 518 to isolate the VM 516 and the GPU state data 530 from the host OS 514.

Referring now to FIG. 6, FIG. 6 shows an example of an architecture 600 that may enable the host OS 514 and the VM 516 to use corresponding GPU state data within the GPU 504, in accordance with some embodiments of the present disclosure. As indicated in FIG. 6, the hypervisor 518 and/or other trusted software (and/or hardware) within the TCB 550 may be configured to assign and/or manage interfaces between the host OS(s) 514, the VM(s) 516, and/or GPU hardware 604 to provide isolation between the various components. For example, the interfaces may include one or more physical interfaces 610A and one or more virtual interfaces 610B to communicate with the GPU hardware 604. Thus, the host OS 514 may have ownership of the GPU 504. In the example shown, the hypervisor 518 isolates the physical interface 610A used by the host OS 514 from the virtual interface 610B used by the VM 516. In at least one embodiment, the host OS 514 may use one or more virtual interfaces that are outside of the TCB 550.

As indicated in FIG. 6, the physical interface(s) 610A may provide one or more communication channels 662 for communication between the host OS 514 and other components, such as the GPU hardware 604. Similarly, the virtual interface(s) 610B may provide one or more communication channels 660 for communication between the VM(s) 516 and other components, such as the GPU hardware 604. In at least one embodiment, the communication channel(s) 660 may comprise at least part of the communication channel(s) 560 of FIG. 5. Also in at least one embodiment, the physical interface(s) 610A and the virtual interface(s) 610B (also referred to as “interfaces 610”) may include one or more network interfaces, such as peripheral component interconnect express (PCIe) interfaces. By way of example, and not limitation, the physical interface(s) 610A may include one or more physical functions and the virtual interface(s) 610B may include one or more virtual functions.

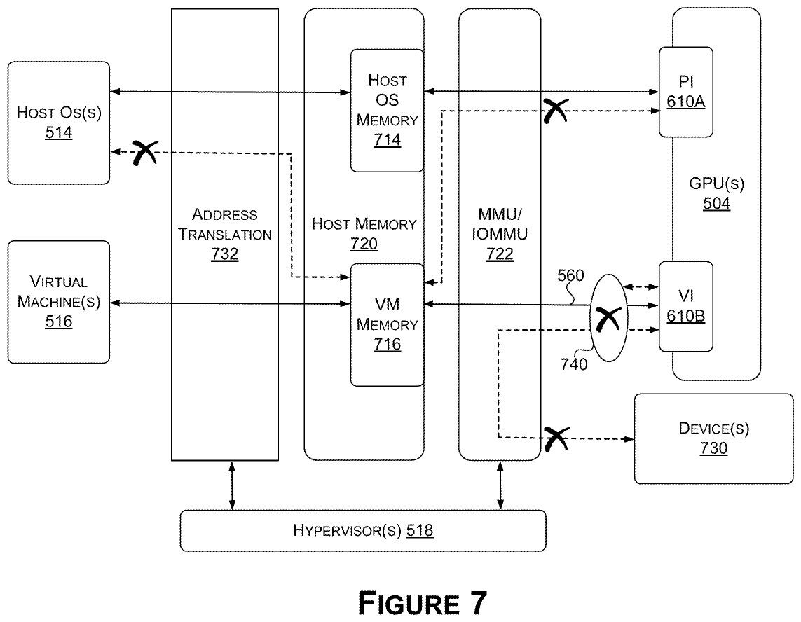

In at least one embodiment, the hypervisor 518 may isolate one or more of the interfaces 610 using single root I/O virtualization (SR-IOV) and/or another virtualization technology. In one or more embodiments, each interface 610 may be assigned a unique requester identifier (RID) that allows a memory management unit (MMU), such as an input-output MMU (IOMMU) of FIG. 7, to differentiate between different traffic streams and apply memory and interrupt translations between the interfaces 610. This may allow traffic streams to be delivered directly to the appropriate partition. As such, graphics hardware may be shared in a manner that allows for responsiveness and low latency among multiple tenants.

FIG. 6 also shows an example where the host OS(s) 514 uses a driver(s) 602A to communicate with the GPU hardware 604 and the VM(s) 516 uses a driver(s) 602B to communicate with the GPU hardware 604. The driver 602A and the driver 602B (also referred to as “drivers 602”) may include one or more user mode drivers and/or one or more kernel mode drivers. FIG. 6 also shows an example where the host OS(s) 514 includes an application(s) 616A and the VM 516 includes the application(s) 616B (also referred to as “applications 616”). The application 616A may be similar to or different than the application 616B. In at least one embodiment, an application(s) 616 may present graphics to a graphics Application Programming Interface (API), such as OpenGL or DirectX, which may be implemented using a user mode driver 602. The user mode driver 602 may communicate the graphics through a kernel mode driver 602, which may present the graphics using an interface(s) 610 for display using the display(s) 110.

In at least one embodiment, the application 616B (e.g., a game) runs as an application instance in the VM 516. In one or more embodiments, the host OS 514 may include a window manager used to control the placement and/or appearance of windows. For example, the host OS 514 may launch the VM 516, causing the hypervisor 518 to assign a virtual interface 610B to the VM 516 and/or causing the application 616B to be run and presented (e.g., responsive to launching the VM 516) in a windowed or full screen mode. In at least one embodiment, the VM 516 may be launched (e.g., using an application 616A) responsive to one or more user inputs to an input device 508. In at least one embodiment, the VM 516 may comprise a trimmed down and/or lightweight operating environment, such as Windows Sandbox. In at least one embodiment, the operating environment may load each time in a same state. For example, data may not persist between launches of the VM 516 and the VM 516 may be loaded from immutable state data. In one or more embodiments, the VM 516 may correspond to immutable and mutable state data. For example, virtualization components may correspond to immutable state data. Mutable state data for the VM 516 may include save files, temporary files, etc. The operating environment may use hardware-based virtualization for kernel isolation with an integrated kernel scheduler and memory manager.

In at least one embodiment, the GPU hardware 604 may perform final compositing of frames for display using the display(s) 110. For example, where display data from the VM 516 is included (e.g., in a window) in a frame for output to the display 110 along with content from one or more other VMs and/or the host OS, the GPU hardware 604 may perform final compositing of the frame to maintain isolation of display data from the host OS and/or other VMs.

As described herein, the one or more verified properties of the TCB 550 may include the hypervisor 518 and/or other trusted components isolating the VM 516 and the GPU state data 530 from the host OS 514 based at least on controlling one or more isolation primitives. Referring now to FIG. 7, FIG. 7 illustrates an example of the hypervisor 518 controlling the MMU/IOMMU 722 and address translation 732 to isolate the GPU state data 530 and the VM 516 from untrusted entities, in accordance with some embodiments of the present disclosure. For example, the hypervisor 518 may prevent the host OS 514 from accessing VM memory 716 assigned to the VM 516 in host memory 720 based at least on controlling the MMU/IOMMU 722 and/or the address translation 732 (e.g., second-level address translation (SLAT)) used to access the VM memory 716. FIG. 7 uses dashed lines to indicate various attack vectors which may be blocked using the hypervisor 518. As shown in FIG. 7, the hypervisor 518 may protect the VM memory 716 from one or more devices 730, such as devices external to the host device and/or peripheral devices, examples of which may include the input device(s) 508 and/or the display(s) 110.

In at least one embodiment, the host OS 514 uses the hypervisor 518 to assign the VM memory 716 to the VM 516 (e.g., when the VM 516 is launched). While the VM 516 is running, the hypervisor 518 and/or the GPU 504 may prevent the host OS 514 from accessing the VM memory 716 assigned to the VM 516.

In at least one embodiment, the hypervisor 518 may be incapable of or ineffective at blocking an attack vector 740. For example, at least a portion of the communication channel(s) 660 may be vulnerable to interposer attacks, for example, when the interface(s) 610 is connected to an exposed bus (e.g., external to a chip package(s) of the host device(s)). An exposed bus may be used, for example, where the GPU(s) 504 includes a discrete GPU (e.g., for CPU-GPU communication). In one or more embodiments, to ameliorate the attack vector 740 and/or other attack vectors, at least one of the communication channels 560, 660, 662 and/or other communication channels may be encrypted. Further, the one or more verified properties of the TCB 550 may be that the communication channel(s) are encrypted and/or that non-encrypted/authenticated data is to be blocked. In at least one embodiment, the VM 516 (e.g., the driver 602B) may establish one or more secure communication channels, such as the communication channel(s) 560 using the virtual interface(s) 610B. This process may include, for example, a handshake and/or initialization of the GPU state data 530 and/or the GPU hardware 604. In at least one embodiment, one or more of the secure channels may be used by the VM 516 to receive one or more attestation reports from the GPU(s) 504.

The encryption may be implemented sing hardware accelerated encryption, hardware native encryption, and/or software encryption. In at least one embodiment, the VM 516 and the GPU 504 are to encrypt traffic sent to the virtual interface(s) 610B. In at least one embodiment, application state and related command and configuration data is encrypted on all buses external to the chip package(s). Additionally, or alternatively, data may be verified (e.g., using the hypervisor 518) for integrity after exposure to any bus external to a chip package(s). In at least one embodiment, the one or more verified properties of the TCB 550 may include any combination of these properties.

Various functionality described herein as being performed using the hypervisor 518 may be performed using additional and/or different trusted components, such as trusted hardware and/or software of the TCB 550. In one or more embodiments, the trusted components may include secure encrypted virtualization (SEV) and/or trusted domain extension (TDX) components. In at least one embodiment, the hypervisor 518 is outside of the TCB 550 and may be untrusted in the system 500. However, including the hypervisor 518 in the TCB 550 may provide corresponding properties to the TCB 550 even where the CPU(s) 502 lacks certain protection technology, such as SEV or TDX. Further, the hypervisor 518 may facilitate isolation unavailable to SEV and TDX, such as preventing injection of user input from the host OS(s) 514, modification of display output by the host OS(s) 514, etc.

Other examples of the one or more verified properties of the TCB 550 include that software that can read and/or write application state data of the CPU(s) 502 and/or the GPU(s) 504 is attested to, that devices that have access to the application state data are authorized, that display scanout is to occur at an authorized endpoint(s), that display scanout is to occur from authorized memory, that particular and/or approved software is included in the TCB 550, that an authorized overlay(s) is displayed over representations of application display data in frames, that software that is part of the application TCB is revocable, and/or that the input device(s) 508 is authorized prior to inputs being accepted within the TCB 550.

In at least one embodiment, the one or more verified properties of the TCB 550 may correspond to software to detect misuse of the application(s) 616B and/or an application instance(s), such as anti-cheat software. The software may attempt to detect particular cheats or behavior and take a remedial action when a cheat is detected. As the software is included in the TCB 550 and captured in the attestation report(s), circumventing or bypassing detection may be significantly more difficult. In at least one embodiment, the software may be to detect frame modification and/or non-human or modified user input.

As described herein, the VM 516 may receive at least one attestation report from the CPU(s) 502. For example, the VM 516 may receive at least one attestation report from a trusted component(s) of the CPU(s) 502, such as the hypervisor 518. The at least one attestation report from the CPU(s) 502 may be generated, at least in part, by the CPU(s) 502. For example, the at least one attestation report may be generated at least in part, by a trusted component(s) of the CPU(s) 502, such as the hypervisor 518. In at least one embodiment, the at least one attestation report is generated and provided using at least one chain of trust rooted in the CPU(s) 502 (a hardware root of trust).

Similarly, the VM 516 may receive one or more attestation reports from the GPU(s) 504 (e.g., over a communication channel 560). For example, the VM 516 may receive at least one attestation report from a trusted component(s) of the GPU(s) 504, such as the trusted software 520. The at least one attestation report from the GPU(s) 504 may be generated, at least in part, by the GPU(s) 504. For example, the at least one attestation report may be generated at least in part, by a trusted component(s) of the GPU(s) 504, such as the trusted software 520. In at least one embodiment, the at least one attestation report is generated and provided using at least one chain of trust rooted in the GPU(s) 504 (a hardware root of trust separate from the hardware root of trust of the CPU(s) 502).

Measurements captured using an attestation report(s) may correspond to code, data, hardware and/or software state and/or configurations, fuse settings, device modes, version information, and/or orderings (e.g., of loading, launching, and/or booting one or more elements for the TCB 550). In one or more embodiments, the attestation report(s) provided to the attestation manager 140 and/or used by the attestation service(s) 122 to verify the TCB 550 may capture measurements of all software that is running in and/or is to be run in the TCB 550 (e.g., during an application session). The software may include firmware and/or microcode on any device used to implement the TCB 550. Software configurations that can impact the completeness or accuracy of the measurements may be captured in the attestation report(s) (e.g., tested mode, secure boot state). Further, hardware configurations for all devices that can impact application state may be captured in the attestation report(s).

Measurements used to generate an attestation report(s) may be generated in a deterministic manner. In one or more embodiments, attestation may include a measured boot of the hypervisor 518 to the exclusion of the host OS(s) 514, a measured boot of the VM(s) 516, and a measured boot of the GPU(s) 504. A measured boot may store measurements of boot components and attestation to the validity of measurements by an attestor (e.g., the attestation service(s) 122). In one or more embodiments, a secure or trusted boot may be used which may include authentication of components via cryptographic verification.

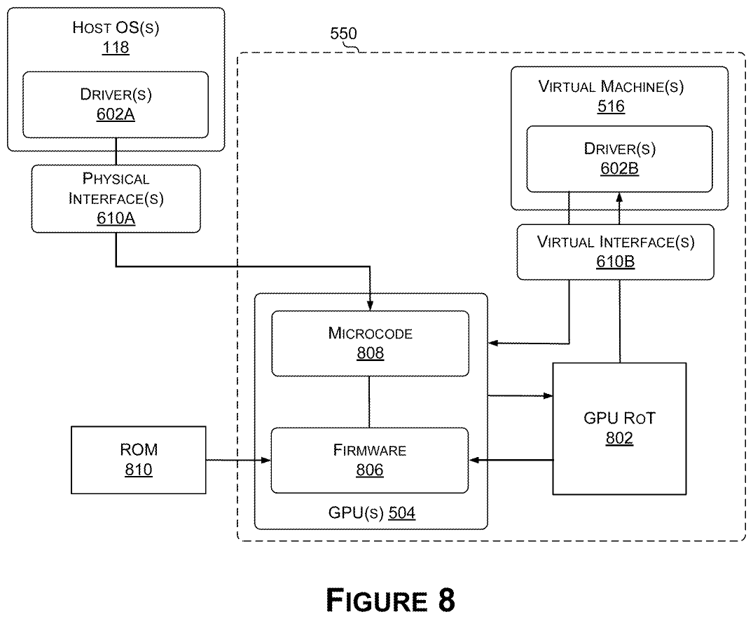

Referring now to FIG. 8, FIG. 8 illustrates an example of using a GPU root of trust 802 for attestation, in accordance with some embodiments of the present disclosure. In at least one embodiment, the GPU 504 uses a measured and attested boot to load firmware 806 and microcode 808. The firmware 806 may be loaded from read-only memory (ROM) 810 and the microcode 808 may be loaded from the host OS(s) 514. The microcode 808 may be relied upon to enforce isolation of GPU resources used by the VM 516. Thus, the GPU 504 may use the root of trust (RoT) 802 to verify the firmware 806, the microcode 808, and/or other data is trustworthy. For example, the RoT 802 may be used to authenticate and measure the firmware 806 and the microcode 808 for generation of an attestation report(s) provided to the attestation manager 140. In at least one embodiment, the GPU 504 may generate the attestation report(s) using a secure boot. In the secure boot, all code to be run may be authenticated and measured. The GPU 504 may use a session key exchange that uses, for example, a security protocol and data model (SPDM) to retrieve the firmware 806 and/or the microcode 808.

### Verification of User Inputs

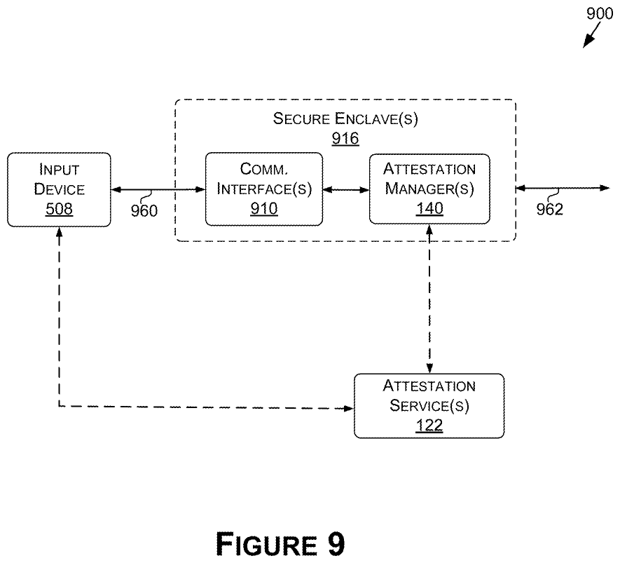

Referring now to FIG. 9, FIG. 9 depicts an example of a user input verification system 900 (also referred to as “system 900”), in accordance with some embodiments of the present disclosure. One or more embodiments of the present disclosure provide for verification of user input from one or more input devices, such as one or more of the input devices 508 described herein. Disclosed approaches may be used, for example, in combination with the system 100, the system 500, and/or other systems employing user input. For example, disclosed approaches may be used to verify one or more properties of one or more execution environments for generating and/or transmitting one or more user inputs. In at least one embodiment, the one or more execution environments may correspond to one or more of the execution environments and/or TCBs being verified using the system 100 and/or the system 500.

The system 900 includes the input device 508, the attestation service(s) 122, and a secure enclave(s) 916. The secure enclave includes a communication interface(s) 910 and the attestation manager(s) 140. While the attestation service(s) 122 is shown as being external to the secure enclave(s) 916, in one or more embodiments, at least a portion of the attestation service(s) 122 may be included int the secure enclave(s) 916 and/or another execution environment.

The secure enclave(s) 916 may include one or more execution environments providing CPU and/or GPU hardware-level isolation between executing application code and data. The execution environment(s) may facilitate the isolation using memory encryption. The execution environment(s) may secure user data, such as one or more security keys and/or application data from direct access by the processor(s).

In at least one embodiment, the secure enclave 916 corresponds to one or more portions of the TCB 550 of FIG. 5. In at least one embodiment, the communication interface 910 and the attestation manager 140 are included in the VM 516 of FIG. 5. In at least one embodiment, one or more of the attestation reports received by the attestation manager 140 may be received from the input device 508 over a communication channel(s) 960. For example, the input device 508 may generate one or more attestation reports indicating one or more properties of an execution environment for generating user input data using the input device 508. The one or more properties may be similar to or different than the one or more properties described with respect to other execution environments here. For example, the one or more properties may indicate firmware, software, and/or hardware components and/or configurations for the input device 508.

In one or more embodiments, the input device 508 may use a RoT of the input device 508 to verify firmware, the microcode, and/or other data corresponding to the execution environment is trustworthy. For example, the ROT may be used to authenticate and measure the execution environment for generation of an attestation report(s) provided to the attestation manager 140. In at least one embodiment, the input device 508 may generate the attestation report(s) using a secure boot. In the secure boot, all code to be run may be authenticated and measured. The input device 508 may use a session key exchange that uses, for example, a security protocol and data model (SPDM) to retrieve the firmware and/or the microcode from memory and/or the host OS 514.

The attestation report(s) may be provided to the attestation manager 140 over the communication channel(s) 960 at any suitable time. In at least one embodiment, the communication interface 910 establishes the communication channel(s) 960 as one or more secure communication channels. This process may include, for example, a handshake (e.g., key exchange) with and/or initialization of the input device 508. In at least one embodiment, the communication interface 910 is included in the VM 516 of FIG. 5. For example, the communication interface 910 may correspond to the driver 602B and/or another driver of the VM 516 (e.g., an input device driver).

The attestation report(s) may be generated, re-generated, and/or provided to the attestation manager 140 at any suitable time or times. In one or more embodiments, the input device 508 may push one or more attestation report(s) to the secure enclave (e.g., responsive to generating the attestation report(s)). In one or more embodiments, the input device 508 may transmit one or more attestation report(s) to the secure enclave responsive to a request for the attestation report(s)). The attestation report(s) from the input device 508 may be verified using attestation service(s) 122.

As indicated in FIG. 9, in at least one embodiment, in addition to or alternatively from providing the attestation report(s) to the secure enclave 916, the input device 508 may provide the attestation report(s) to the attestation service(s) 122. As described herein, the attestation service 122 may be included in a server (e.g., the server 104), the secure enclave(s) 916, and/or another device or environment. By verifying the execution environment for the input device 508, the attestation service(s) 122 may ensure user inputs from the input device 508 are trusted and less vulnerable to manipulation and/or synthetic generation. In one or more embodiments, one or more of the content items 130 may be associated with one or more application sessions to indicate the one or more properties of the execution environment(s) corresponding to the input device(s) 508 comply with the one or more security policies.

The user inputs from the input device 508 may be used with the secure enclave(s) 916 and/or data representing the user inputs or corresponding to the user inputs (e.g., data generated using the user inputs) may be provided to one or more other execution environments and/or components for consumption. For example, a communication channel(s) 962 may be used to provide the data to another entity. Disclosed approaches may allow for strong assertions (from a security standpoint) around one or more properties of one or more execution environments that are providing the data, with evidence that no unexpected modifications of the data and/or software elements have occurred (e.g., within a secure enclave 916). For example, the communication channel(s) 962 may be used to provide the data one or more other trusted entities (e.g., secure enclaves), which may similarly provide one or more attestation reports to the attestation service(s) 122 and/or another trusted entity. In one or more embodiments, the communication channel(s) 962 (e.g., external channels) between each trusted entity may include an encrypted communication channel(s), similar to or different than the communication channel(s) 960. For example, any external channels between execution environments and/or devices may include encrypted communication channel(s) from the input device 508 to the device(s) used to display and/or present the media.

Thus, using disclosed approaches, a chain of trust may be formed that extends from generation of the user inputs to consumption of data corresponding to the user inputs. Disclosed approaches may be used for various applications, of which gaming is one example. In one or more embodiments, disclosed approaches may be used to provide a chain of trust for video generated using a video camera, such as to provide assurance that the video is genuine and/or that content depicted in the video and/or metadata thereof is genuine. For example, disclosed approaches may be used for providing protection from deepfake media in which a person in an existing image or video is replaced with someone else's likeness. This may include, for example, attesting to the path from physical input (camera/microphone) to encoded video stream such that a viewer of the video can verify the video/audio they are consuming came from a genuine source. Additionally, or alternatively, disclosed approaches may be used for persona verification so as to tie a virtual persona or avatar to a real identity. This may include, for example, attesting to the set of transforms applied to a genuine user input (e.g., attesting to one or more AI models and/or algorithms that video data is run through before being transmitted and/or consumed.

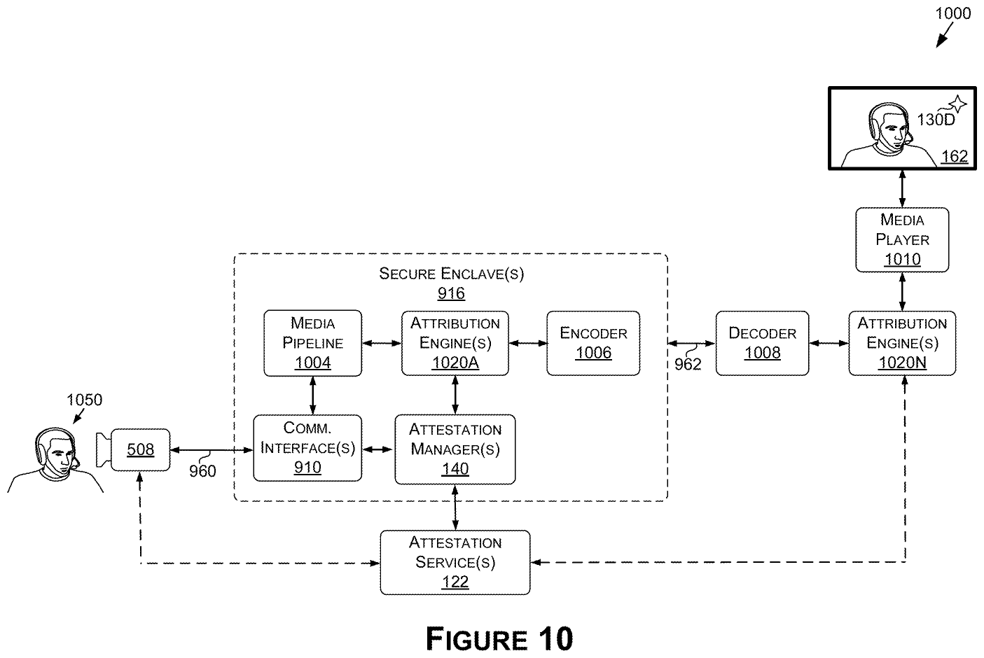

Referring now to FIG. 10, FIG. 10 depicts an example of a video input verification system 1000 (also referred to as “system 1000”), in accordance with some embodiments of the present disclosure. The system 1000 may, for example, correspond to the system 900 of FIG. 9.

The system 1000 includes a media pipeline 1004, an encoder 1006, a decoder 1008, a media player 1010, and one or more attribution engines 1020A through 1020N (also referred to as “attribution engines 1020”). The system 1000 may be used for video input verification in video streaming, recording, and/or playback applications, such as for deepfake protection and/or persona verification. For example, the system 1000 may be used to provide deepfake protection and/or persona verification in relation to a user 1050 captured by the input device(s) 508 (e.g., a video camera).

As indicated in FIG. 10, the system 1000 may be used to capture and playback the video 162 of FIG. 1. For example, the system 1000 may be incorporated, at least in part, into the system 100 of FIG. 1. In one or more embodiments, the video 162 may be captured using a same or a different application session as the game session(s) 132 and/or a same or a different application as the game session(s) 132. In one or more embodiments, the system 1000 may be implemented without using the system 100 and/or one or more components thereof.

The media pipeline 1004 may be configured to perform one or more processing operations on video data captured using the input device 508 and received using the communication interface 910. The encoder 1006 may be configured to encode the video data processed using the media pipeline 1004. The secure enclave(s) 916 may provide (e.g., using the communication interface(s) 910) the encoded video data to one or more external entities (e.g., one or more trusted entities, which may include one or more secure enclaves), which may include the decoder 1008. The decoder 1008 may be configured to decode the encoded video data. The media player 1010 may be configured to playback the decoded video data. In at least one embodiment, the media player 1010 correspond to the gaming application 106 and/or the viewing application 112 for one or more client devices 102.

The attribution engines 1020 (e.g., software entities) of the system 1000 may be configured to make attestations and/or claims regarding how the video data was processed or otherwise handled by a corresponding secure enclave and/or trusted entity. The attestations may additively extend any previous claims (e.g., attestation reports) corresponding to the video data from the input device 508. In one or more embodiments, each attribution engine 1020 may add corresponding assertions under the signing authority of the entity.

One or more of the attribution engines 1020 may additionally or alternatively be configured to review one or more attestation reports corresponding to the video data to determine whether the video data is to be trusted by the corresponding entity. For example, where an analysis of the attestation reports and/or video data indicates the video data has been falsified, tampered with, or is otherwise untrustworthy, an attribution engine 1020 may determine the video data is untrustworthy. In at least one embodiment, at least a portion of the determination may be performed using the attestation service(s) 122.

In at least one embodiment, at least a portion of the analysis (using any combination of the various attribution engines 1020) may use one or more machine learning models (MLMs) to analyze data indicating and/or representing one or more portions of the attestation reports and/or the received video data. In at least one embodiment, one or more machine learning models, such as one or more convolutional neural networks, may be used to analyze one or more video and/or audio frames of the video 162 to determine whether the data is trustworthy. The analysis may, for example, be based at least on verbal and/or auditory cues captured in the data relative to known biometric references (e.g., of the user purportedly captured by the data). For example, the biometric data, such as one or more known images and/or audio captures of the purported entity may be provided as input to the MLM along with data one or more portions of the data purported to capture the entity. The MLM may be trained to predict whether the data corresponds to the entity, an attribution engine 1020 may determine whether the data is trustworthy based at least on the prediction.

The MLM(s) and other MLMs described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, one or more neural networks (e.g., auto-encoders, convolutional, recurrent, perceptrons, Long/Short Term Memory (LSTM), Hopfield, Boltzmann, deep belief, deconvolutional, generative adversarial, and/or liquid state machine, etc.), and/or other types of machine learning models.

A determination that the video data is untrustworthy may alter the way the video data is used in the system 1000 comparted to when the video data is determined to be trustworthy. For example, if an attribution engine 1020 determines the video data from the decoder 1008 is untrustworthy, the media player 1010 may not display the content item 130D with the video 162 and/or the content item 130D may not be included in the video 162. As another example, the video 162 may be displayed with and/or include a disclaimer or other indication that the attribution engine 1020 and/or the attestation service(s) 122 was unable to verify the video data as trustworthy. If each attribution engine 1020 determines the video data from the decoder 1008 is trustworthy, the media player 1010 may display the content item 130D with the video 162 and/or the content item 130D may be included in the video 162. As another example, the video 162 may be displayed with and/or include an indication that each attribution engine 1020 and/or the attestation service(s) 122 was able to verify the video data as trustworthy. In one or more embodiments, the indication may be included in metadata of the video 162, and/or the indication may be recorded in the database, as described herein.

The media pipeline 1004 may include, as examples, broadcasting software, video effects software, and/or video filtering software. Each software component may use an attribution engine 1020 to make one or more attestations regarding how the video data was handled by the software component. For example, the broadcasting software may claim the sensor data was not substantively altered was faithfully translated within the software environment. The video effects software may claim only white balance and noise cancellation adjustments were made and that the video data was otherwise faithfully translated. Similarly, the video filtering software may claim that only video filtering was performed and that the video data was otherwise faithfully translated. This chain of attestation may continue for each entity that handles the video data, and a receiver at the end of the media stream (e.g., the attribution engine 1020N) can review such claims to determine whether they are supported by the enclave(s) and/or whether the video data is trustworthy. For example, the chain may include attestations made using one or more entities on a client endpoint(s) used to capture and/or display the video data, and one or more intermediate entities, such as cloud-based entities.

### Example Content Streaming System

Now referring to FIG. 11, FIG. 11 is an example system diagram for a content streaming system 1100, in accordance with some embodiments of the present disclosure. FIG. 11 includes application server(s) 1102 (which may include similar components, features, and/or functionality to the example computing device 1200 of FIG. 12), client device(s) 1104 (which may include similar components, features, and/or functionality to the example computing device 1200 of FIG. 12), and network(s) 1106 (which may be similar to the network(s) described herein). In some embodiments of the present disclosure, the system 1100 may be implemented. The application session may correspond to a game streaming application (e.g., NVIDIA GeForce NOW), a remote desktop application, a simulation application (e.g., autonomous or semi-autonomous vehicle simulation), computer aided design (CAD) applications, virtual reality (VR), augmented reality (AR), and/or mixed reality (MR) streaming applications, deep learning applications, and/or other application types.

In the system 1100, for an application session, the client device(s) 1104 may only receive input data in response to inputs to the input device(s), transmit the input data to the application server(s) 1102, receive encoded display data from the application server(s) 1102, and display the display data on the display 1124. As such, the more computationally intense computing and processing is offloaded to the application server(s) 1102 (e.g., rendering—in particular ray or path tracing—for graphical output of the application session is executed by the GPU(s) of the application server(s) 1102). In other words, the application session is streamed to the client device(s) 1104 from the application server(s) 1102, thereby reducing the requirements of the client device(s) 1104 for graphics processing and rendering.

For example, with respect to an instantiation of an application session, a client device 1104 may be displaying a frame of the application session on the display 1124 based on receiving the display data from the application server(s) 1102. The client device 1104 may receive an input to one of the input devices(s) and generate input data in response. The client device 1104 may transmit the input data to the application server(s) 1102 via the communication interface 1120 and over the network(s) 1106 (e.g., the Internet), and the application server(s) 1102 may receive the input data via the communication interface 1118. The CPU(s) may receive the input data, process the input data, and transmit data to the GPU(s) that causes the GPU(s) to generate a rendering of the application session. For example, the input data may be representative of a movement of a character of the user in a game session of a game application, firing a weapon, reloading, passing a ball, turning a vehicle, etc. The rendering component 1112 may render the application session (e.g., representative of the result of the input data) and the render capture component 1114 may capture the rendering of the application session as display data (e.g., as image data capturing the rendered frame of the application session). The rendering of the application session may include ray or path-traced lighting and/or shadow effects, computed using one or more parallel processing units-such as GPUs, which may further employ the use of one or more dedicated hardware accelerators or processing cores to perform ray or path-tracing techniques-of the application server(s) 1102. In some embodiments, one or more virtual machines (VMs)—e.g., including one or more virtual components, such as vGPUs, vCPUs, etc.—may be used by the application server(s) 1102 to support the application sessions. The encoder 1116 may then encode the display data to generate encoded display data and the encoded display data may be transmitted to the client device 1104 over the network(s) 1106 via the communication interface 1118. The client device 1104 may receive the encoded display data via the communication interface 1120 and the decoder 1122 may decode the encoded display data to generate the display data. The client device 1104 may then display the display data via the display 1124.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

### Example Computing Device

FIG. 12 is a block diagram of an example computing device(s) 1200 suitable for use in implementing some embodiments of the present disclosure. Computing device 1200 may include an interconnect system 1202 that directly or indirectly couples the following devices: memory 1204, one or more central processing units (CPUs) 1206, one or more graphics processing units (GPUs) 1208, a communication interface 1210, input/output (I/O) ports 1212, input/output components 1214, a power supply 1216, one or more presentation components 1218 (e.g., display(s)), and one or more logic units 1220. In at least one embodiment, the computing device(s) 1200 may comprise one or more virtual machines (VMs), and/or any of the components thereof may comprise virtual components (e.g., virtual hardware components). For non-limiting examples, one or more of the GPUs 1208 may comprise one or more vGPUs, one or more of the CPUs 1206 may comprise one or more vCPUs, and/or one or more of the logic units 1220 may comprise one or more virtual logic units. As such, a computing device(s) 1200 may include discrete components (e.g., a full GPU dedicated to the computing device 1200), virtual components (e.g., a portion of a GPU dedicated to the computing device 1200), or a combination thereof.

Although the various blocks of FIG. 12 are shown as connected via the interconnect system 1202 with lines, this is not intended to be limiting and is for clarity only. For example, in some embodiments, a presentation component 1218, such as a display device, may be considered an I/O component 1214 (e.g., if the display is a touch screen). As another example, the CPUs 1206 and/or GPUs 1208 may include memory (e.g., the memory 1204 may be representative of a storage device in addition to the memory of the GPUs 1208, the CPUs 1206, and/or other components). In other words, the computing device of FIG. 12 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 12.

The interconnect system 1202 may represent one or more links or busses, such as an address bus, a data bus, a control bus, or a combination thereof. The interconnect system 1202 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1206 may be directly connected to the memory 1204. Further, the CPU 1206 may be directly connected to the GPU 1208. Where there is direct, or point-to-point connection between components, the interconnect system 1202 may include a PCIe link to carry out the connection. In these examples, a PCI bus need not be included in the computing device 1200.

The memory 1204 may include any of a variety of computer-readable media. The computer-readable media may be any available media that may be accessed by the computing device 1200. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1204 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1200. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1206 may be configured to execute at least some of the computer-readable instructions to control one or more components of the computing device 1200 to perform one or more of the methods and/or processes described herein. The CPU(s) 1206 may each include one or more cores (e.g., one, two, four, eight, twenty-eight, seventy-two, etc.) that are capable of handling a multitude of software threads simultaneously. The CPU(s) 1206 may include any type of processor and may include different types of processors depending on the type of computing device 1200 implemented (e.g., processors with fewer cores for mobile devices and processors with more cores for servers). For example, depending on the type of computing device 1200, the processor may be an Advanced RISC Machines (ARM) processor implemented using Reduced Instruction Set Computing (RISC) or an x86 processor implemented using Complex Instruction Set Computing (CISC). The computing device 1200 may include one or more CPUs 1206 in addition to one or more microprocessors or supplementary co-processors, such as math co-processors.

In addition to or alternatively from the CPU(s) 1206, the GPU(s) 1208 may be configured to execute at least some of the computer-readable instructions to control one or more components of the computing device 1200 to perform one or more of the methods and/or processes described herein. One or more of the GPU(s) 1208 may be an integrated GPU (e.g., with one or more of the CPU(s) 1206 and/or one or more of the GPU(s) 1208 may be a discrete GPU. In embodiments, one or more of the GPU(s) 1208 may be a coprocessor of one or more of the CPU(s) 1206. The GPU(s) 1208 may be used by the computing device 1200 to render graphics (e.g., 3D graphics) or perform general purpose computations. For example, the GPU(s) 1208 may be used for General-Purpose computing on GPUs (GPGPU). The GPU(s) 1208 may include hundreds or thousands of cores that are capable of handling hundreds or thousands of software threads simultaneously. The GPU(s) 1208 may generate pixel data for output images in response to rendering commands (e.g., rendering commands from the CPU(s) 1206 received via a host interface). The GPU(s) 1208 may include graphics memory, such as display memory, for storing pixel data or any other suitable data, such as GPGPU data. The display memory may be included as part of the memory 1204. The GPU(s) 1208 may include two or more GPUs operating in parallel (e.g., via a link). The link may directly connect the GPUs (e.g., using NVLINK) or may connect the GPUs through a switch (e.g., using NVSwitch). When combined together, each GPU 1208 may generate pixel data or GPGPU data for different portions of an output or for different outputs (e.g., a first GPU for a first image and a second GPU for a second image). Each GPU may include its own memory or may share memory with other GPUs.

In addition to or alternatively from the CPU(s) 1206 and/or the GPU(s) 1208, the logic unit(s) 1220 may be configured to execute at least some of the computer-readable instructions to control one or more components of the computing device 1200 to perform one or more of the methods and/or processes described herein. In embodiments, the CPU(s) 1206, the GPU(s) 1208, and/or the logic unit(s) 1220 may discretely or jointly perform any combination of the methods, processes and/or portions thereof. One or more of the logic units 1220 may be part of and/or integrated in one or more of the CPU(s) 1206 and/or the GPU(s) 1208 and/or one or more of the logic units 1220 may be discrete components or otherwise external to the CPU(s) 1206 and/or the GPU(s) 1208. In embodiments, one or more of the logic units 1220 may be a coprocessor of one or more of the CPU(s) 1206 and/or one or more of the GPU(s) 1208.

Examples of the logic unit(s) 1220 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1210 may include one or more receivers, transmitters, and/or transceivers that enable the computing device 1200 to communicate with other computing devices via an electronic communication network, included wired and/or wireless communications. The communication interface 1210 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1220 and/or communication interface 1210 may include one or more data processing units (DPUs) to transmit data received over a network and/or through interconnect system 1202 directly to (e.g., a memory of) one or more GPU(s) 1208.

The I/O ports 1212 may enable the computing device 1200 to be logically coupled to other devices including the I/O components 1214, the presentation component(s) 1218, and/or other components, some of which may be built in to (e.g., integrated in) the computing device 1200. Illustrative I/O components 1214 include a microphone, mouse, keyboard, joystick, game pad, game controller, satellite dish, scanner, printer, wireless device, etc. The I/O components 1214 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1200. The computing device 1200 may be include depth cameras, such as stereoscopic camera systems, infrared camera systems, RGB camera systems, touchscreen technology, and combinations of these, for gesture detection and recognition. Additionally, the computing device 1200 may include accelerometers or gyroscopes (e.g., as part of an inertia measurement unit (IMU)) that enable detection of motion. In some examples, the output of the accelerometers or gyroscopes may be used by the computing device 1200 to render immersive augmented reality or virtual reality.

The power supply 1216 may include a hard-wired power supply, a battery power supply, or a combination thereof. The power supply 1216 may provide power to the computing device 1200 to enable the components of the computing device 1200 to operate.

The presentation component(s) 1218 may include a display (e.g., a monitor, a touch screen, a television screen, a heads-up-display (HUD), other display types, or a combination thereof), speakers, and/or other presentation components. The presentation component(s) 1218 may receive data from other components (e.g., the GPU(s) 1208, the CPU(s) 1206, DPUs, etc.), and output the data (e.g., as an image, video, sound, etc.).

### Example Data Center

FIG. 13 illustrates an example data center 1300 that may be used in at least one embodiments of the present disclosure. The data center 1300 may include a data center infrastructure layer 1310, a framework layer 1320, a software layer 1330, and/or an application layer 1340.

As shown in FIG. 13, the data center infrastructure layer 1310 may include a resource orchestrator 1312, grouped computing resources 1314, and node computing resources (“node C.R.s”) 1316(1)-1316(N), where “N” represents any whole, positive integer. In at least one embodiment, node C.R.s 1316(1)-1316(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1316(1)-1316(N) may correspond to a server having one or more of the above-mentioned computing resources. In addition, in some embodiments, the node C.R.s 1316(1)-13161(N) may include one or more virtual components, such as vGPUs, vCPUs, and/or the like, and/or one or more of the node C.R.s 1316(1)-1316(N) may correspond to a virtual machine (VM).

In at least one embodiment, grouped computing resources 1314 may include separate groupings of node C.R.s 1316 housed within one or more racks (not shown), or many racks housed in data centers at various geographical locations (also not shown). Separate groupings of node C.R.s 1316 within grouped computing resources 1314 may include grouped compute, network, memory or storage resources that may be configured or allocated to support one or more workloads. In at least one embodiment, several node C.R.s 1316 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1312 may configure or otherwise control one or more node C.R.s 1316(1)-1316(N) and/or grouped computing resources 1314. In at least one embodiment, resource orchestrator 1312 may include a software design infrastructure (SDI) management entity for the data center 1300. The resource orchestrator 1312 may include hardware, software, or some combination thereof.

In at least one embodiment, as shown in FIG. 13, framework layer 1320 may include a job scheduler 1328, a configuration manager 1334, a resource manager 1336, and/or a distributed file system 1338. The framework layer 1320 may include a framework to support software 1332 of software layer 1330 and/or one or more application(s) 1342 of application layer 1340. The software 1332 or application(s) 1342 may respectively include web-based service software or applications, such as those provided by Amazon Web Services, Google Cloud and Microsoft Azure. The framework layer 1320 may be, but is not limited to, a type of free and open-source software web application framework such as Apache Spark™ (hereinafter “Spark”) that may utilize distributed file system 1338 for large-scale data processing (e.g., “big data”). In at least one embodiment, job scheduler 1328 may include a Spark driver to facilitate scheduling of workloads supported by various layers of data center 1300. The configuration manager 1334 may be capable of configuring different layers such as software layer 1330 and framework layer 1320 including Spark and distributed file system 1338 for supporting large-scale data processing. The resource manager 1336 may be capable of managing clustered or grouped computing resources mapped to or allocated for support of distributed file system 1338 and job scheduler 1328. In at least one embodiment, clustered or grouped computing resources may include grouped computing resource 1314 at data center infrastructure layer 1310. The resource manager 1336 may coordinate with resource orchestrator 1312 to manage these mapped or allocated computing resources.

In at least one embodiment, software 1332 included in software layer 1330 may include software used by at least portions of node C.R.s 1316(1)-1316(N), grouped computing resources 1314, and/or distributed file system 1338 of framework layer 1320. One or more types of software may include, but are not limited to, Internet web page search software, e-mail virus scan software, database software, and streaming video content software.

In at least one embodiment, application(s) 1342 included in application layer 1340 may include one or more types of applications used by at least portions of node C.R.s 1316(1)-1316(N), grouped computing resources 1314, and/or distributed file system 1338 of framework layer 1320. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1334, resource manager 1336, and resource orchestrator 1312 may implement any number and type of self-modifying actions based on any amount and type of data acquired in any technically feasible fashion. Self-modifying actions may relieve a data center operator of data center 1300 from making possibly bad configuration decisions and possibly avoiding underutilized and/or poor performing portions of a data center.

The data center 1300 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1300. In at least one embodiment, trained or deployed machine learning models corresponding to one or more neural networks may be used to infer or predict information using resources described above with respect to the data center 1300 by using weight parameters calculated through one or more training techniques, such as but not limited to those described herein.

In at least one embodiment, the data center 1300 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1200 of FIG. 12—e.g., each device may include similar components, features, and/or functionality of the computing device(s) 1200. In addition, where backend devices (e.g., servers, NAS, etc.) are implemented, the backend devices may be included as part of a data center 1300, an example of which is described in more detail herein with respect to FIG. 13.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments-in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1200 described herein with respect to FIG. 12. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
receiving first data corresponding to one or more attestation reports generated using one or more host devices, the one or more attestation reports indicating one or more properties of one or more execution environments corresponding to one or more application sessions;
verifying, using the first data, that the one or more properties of the one or more execution environments comply with one or more security policies;
associating one or more in-application content items or units with the one or more application sessions, the associating indicating the one or more properties comply with the one or more security policies; and
based at least on the one or more in-application content items or units being associated with the one or more application sessions, causing, using second data, presentation of the one or more in-application content items or units.

2. The method of claim 1, wherein the one or more in-application content items or units correspond to one or more of:
one or more visual tokens displayed in association with the one or more application sessions;
in-game graphical content displayed during at least a portion of the one or more application sessions;
embedded code of one or more webpages that indicate one or more players associated with the one or more execution environments; or
one or more links to the one or more webpages.

3. The method of claim 1, wherein the causing the presentation includes generating the second data based at least on overlaying the one or more in-application content items or units on video data of one or more video streams of the one or more application sessions.

4. The method of claim 1, wherein the causing the presentation includes transmitting the second data to a data store to generate one or more records of the one or more properties being verified, and the presentation is based at least on the one or more records being queried in the data store.

5. The method of claim 1, wherein the presentation is to a plurality of participants of the one or more application sessions during the one or more application sessions.

6. The method of claim 1, wherein the one or more security policies specify the one or more execution environments are to include a trusted computing base (TCB) having a virtual machine (VM) for executing the one or more application sessions, and the TCB is to isolate the VM from an untrusted host operating system (OS) of the one or more host devices.

7. The method of claim 1, wherein the one or more attestation reports include at least one attestation report corresponding to at least one chain of trust rooted in one or more processing units of the one or more host devices.

8. The method of claim 1, wherein the method includes associating at least one in-application content item or unit with one or more video streams captured using one or more video cameras to indicate at least one property of at least one execution environment of the one or more video cameras complies with at least one security policy, the video stream depicting one or more users captured using the one or more video cameras.

9. The method of claim 1, further comprising receiving one or more requests from the one or more host devices to participate in the one or more application sessions, and the receiving of the first data is based at least on the receiving of the one or more requests.

10. A system comprising:
one or more processing units to perform operations including:
transmitting first data corresponding to one or more attestation reports generated using one or more host devices, the one or more attestation reports indicating one or more properties of an execution environment for participating in one or more application sessions;
receiving second data corresponding to one or more in-application content items or units, the second data indicating verification, using the first data, that the one or more properties of the execution environment comply with one or more security policies; and
causing, using the second data, presentation of the one or more in-application content items or units in association with the one or more application sessions.

11. The system of claim 10, wherein the one or more in-application content items or units correspond to one or more of:
one or more visual tokens displayed in association with the one or more application sessions;
in-game graphical content displayed during at least a portion of the one or more application sessions;
embedded code of one or more webpages that indicate one or more players associated with the one or more execution environments; or
one or more links to the one or more webpages.

12. The system of claim 10, wherein the causing the presentation includes generating the second data based at least on overlaying the one or more in-application content items or units on video data of one or more video streams of the one or more application sessions.

13. The system of claim 10, further comprising querying one or more data stores and the second data corresponds to at least one record of the one or more properties being verified, the at least one record being responsive to the querying.

14. The system of claim 10, wherein the one or more security policies specify the execution environment is to include a trusted computing base (TCB) having a virtual machine (VM) for the participating in the one or more application sessions, and the TCB is to isolate the VM from an untrusted host operating system (OS) of the one or more host devices.

15. The system of claim 10, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system for presenting at least one of virtual reality content, augmented reality content, or mixed reality content;
a system implemented at least partially in a data center; or
a system implemented at least partially using cloud computing resources.

16. A processor comprising:
one or more circuits to cause presentation of one or more in-application content items or units in association with one or more application sessions, the presentation indicating verification of one or more properties of one or more execution environments used to participate in the one or more application sessions.

17. The processor of claim 16, wherein the one or more in-application content items or units correspond to one or more of:
one or more visual tokens displayed in association with the one or more application sessions;
in-game graphical content displayed during at least a portion of the one or more application sessions;
embedded code of one or more webpages that indicate one or more players associated with the one or more execution environments; or
one or more links to the one or more webpages.

18. The processor of claim 16, wherein the causing the presentation includes overlaying the one or more in-application content items or units on video data of one or more video streams of the one or more application sessions.

19. The processor of claim 16, wherein the causing the presentation includes transmitting data to a data store to generate one or more records of the one or more properties being verified, and the presentation is based at least on the one or more records being queried in the data store.

20. The processor of claim 16, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system for presenting at least one of virtual reality content, augmented reality content, or mixed reality content;
a system implemented at least partially in a data center; or
a system implemented at least partially using cloud computing resources.
